(19) United States
(12) Patent Application Publication
(10) Pub. No.: US 2003/0191682 A1
(43) Pub. Date: Oct. 9, 2003

(54) POSITIONING SYSTEM FOR PERCEPTION MANAGEMENT

(75) Inventors: BARRY SHEPARD, PARADISE VALLEY, AZ (US); WILL RODGERS, SCOTTSDALE, AZ (US); BRIAN FIDLER, SCOTTSDALE, AZ (US)

Correspondence Address: MERCHANT & GOULD PC, P.O. BOX 2903, MINNEAPOLIS, MN, 55402-0903, US

(73) Assignee: Allen J. Oh

(21) Appl. No.: 09/407,569

(22) Filed: Sep. 28, 1999

(51) Int. Cl. G06F 17/60

(52) U.S. Cl. 705/10

(57) ABSTRACT

A method, apparatus and article of manufacture for a computer-implemented positioning system for perception management. On a computer system having one or more processors, perception management is performed using a plurality of visual representations stored in a database. The one or more processors and the database being coupled to the computer system. The representations include one or more particular visual representations as well as one or more other visual representations, each visual representation embodies cues, whereupon when viewed by humans, these related cues send signals that influence human behavior by synergistically triggering desired perceptions. Perception management is performed by outputting from the computer system to a user one or more of the particular visual representations on an output device coupled to the computer system. Classification information for the one or more outputted particular visual representations is received from the user using an input device coupled to the one or more processors in the computer system. The classification information received from the user for the one or more outputted particular visual representations is stored in the database. Then, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

### BACKGROUND

1. Field of the Invention

This invention relates, in general, to computer-implemented systems and, in particular, to a positioning system that assists with perception management.

2. Description of Related Art

For many companies, the image the company and its products portray to the public influences the sales of its products. Consumers often make decisions on which products to purchase based on their perception of the product or the company that sells the product. Webster's Ninth New Collegiate Dictionary (1983) defines perception as “a mental image: concept” or as “awareness of the elements of environment through physical sensation,” or sensory elements, for example, visual, auditory, olfactory, taste, tactile, experiential and virtual.

Marketing is used to create a brand image (i.e., an image or perception of a company or a product). A brand image is comprised of multiple influences in the marketplace, some desirable and some not desirable. It is based on the perceptions it portrays or the perception a consumer has toward a product or company. For example, the image may be positive if the product or company is associated with a popular persona. A brand position is the marketer's desired brand image actively communicated to a specific target audience.

Conventional strategies for determining what consumers like and don't like often use focus groups. A focus group is a group of consumers who are asked to try a product and answer questions about it or who are asked to take a survey in an effort to draw out their feelings about a product. Some strategies include one-on-one interviews between a researcher conducting a survey and a consumer in which the consumer is asked to describe a product using a given list of words, watching consumers as they use a product, having consumers keep diaries or calendars to document when they use products and obtaining stories from consumers about using the product.

In today's marketplace, consumers are bombarded with information. They are exposed to thousands of brand names and are introduced to thousands of new brands each year. Marketers of each brand make claims and promises and try to find ways to deliver those claims and promises to their consumers. In this environment, consumers have become so overburdened with information that they have begun discounting and disbelieving factual information.

Accordingly, consumers cope by using signals or “shortcuts.” Today's consumers do not have the time nor the inclination to investigate claims or research purchasing options to previous extents. Today, consumers rely on perceptual signals to form perceptions that drive their purchase decisions.

Another issue with conventional marketers is that the products they deliver are destined to become commodities. Each brand competes for a segment of the market and attempts to craft a message that resonates with that segment. For example, television sets are a product category in which marketers could own a distinct segment of the market. Years ago, RCA owned “reliability” as the promise delivered to television set buyers. However, as more television brands entered the market and as technologies and manufacturing processes improved, the perception of “reliability” became a commodity that virtually all television manufacturers were capable of delivering. “Reliability” became a consumer expectation that all television manufacturers had to meet to compete in the marketplace.

Anthropologists and psychologists report that now 80 percent of information is communicated through nonverbal means. Accordingly, each of the senses and its aggregate experience can be leveraged to communicate a marketplace position more effectively by distilling the cues that send specific signals to the target audience. The synergy of the collection of signals, sent by the multiple cues, triggers the desirable perceptions that influence behavior. For example, a tapering line on a pair of sunglasses in combination with one or more cues may send signals connoting elegance that then creates the perception of elegance.

The drawbacks of conventional techniques are that they may not obtain quantitative data and/or the appropriate qualitative data. Also, some conventional systems may have been able to provide some data on consumer likes and dislikes, but they did not provide a translation from a strategy for developing a particular image to an implementation of that strategy. Additionally, conventional techniques are currently labor-intensive, such as requiring researchers to spend a great deal of time asking consumers questions or administering surveys.

There is a need for an improved technique to assist a company in managing its perceptions in today's competitive marketplace, to differentiate itself from its competitors and to communicate a meaningful proposition of its products to consumers. There is also a need for a positioning system that provides a set of tools to evaluate the position that a company or brand wishes to own, such as “reliable.” Such positioning system then helps to uncover the “ownability” of that position in the market, refine its current position or craft a new position that is “ownable” in the market and true to the values of the company's vision. Furthermore, once an “ownable” position is obtained, there is a need to build a vocabulary of cues (visual, auditory, olfactory, taste, tactile and experiential) that can be used to accurately translate the chosen position at each point of contact with consumers.

### SUMMARY

To overcome the limitations in the prior art described above and to overcome other limitations that will become apparent upon reading and understanding the present specification, the method, apparatus and article of manufacture having features of the invention provide a computer-implemented positioning system for perception management.

In accordance with one embodiment of the invention, on a computer system having one or more processors, perception management is performed using a plurality of visual representations stored in a database. The one or more processors and the database being coupled to the computer system. The representations include one or more particular visual representations as well as one or more other visual representations, each visual representation embodies cues, whereupon when viewed by humans, these related cues send signals that influence human behavior by synergistically triggering desired perceptions. Perception management is performed by outputting from the computer system to a user one or more of the particular visual representations on an output device coupled to the computer system. Classification information for the one or more outputted particular visual representations is received from the user using an input device coupled to the one or more processors in the computer system. The classification information received from the user for the one or more outputted particular visual representations is stored in the database. Then, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

### BRIEF DESCRIPTION OF THE DRAWINGS

Referring now to the drawings in which like reference numbers represent corresponding parts throughout:

FIG. 1 is a diagram of a hardware environment used to implement an embodiment of the invention;

FIG. 2 is a diagram of example steps for arriving at a desired dimension using a translation phase of an image or identity development process;

FIG. 3 is a diagram of dimensions and their opposites;

FIG. 4 is a diagram illustrating a competitive scale relative to an image or identity dimension;

FIG. 5 is a diagram illustrating a display provided by a positioning system for categorizing images;

FIG. 6 is a diagram illustrating a display provided by a positioning system for ranking images;

FIG. 7 is a diagram illustrating a display provided by a visual positioning system for processing information received from users;

FIG. 8 is a diagram of example results of a visual positioning system processing input;

FIG. 9 is a diagram showing an example of a visual position model summary;

FIG. 10 is a diagram of a perceptual map displayed by a visual positioning system;

FIG. 11 is a diagram of a hardware environment that may be used for implementing an embodiment of the invention within a network architecture;

FIG. 12 is an example of a positioning information flow diagram;

FIG. 13 is an example of a computer display screen of a positioning system;

FIG. 14 is an example of a computer display screen of a positioning system including a dialogue box;

FIG. 15 is an example of a computer display screen of a positioning system, including examples of a set of images;

FIG. 16 is an example computer display screen of a positioning system, including an example set of images being sorted;

FIG. 17 is an example of a computer display screen of a positioning system, including example results of observations of several groups;

FIG. 18 is an example of a computer display screen of a positioning system, including an example of a visual cue and example results of observations of several groups;

FIG. 19 is an example of a computer display screen of a positioning system, including an example of a notepad box;

FIG. 20 is an example of a computer display screen of a positioning system, including an example of a notepad window for entering information;

FIG. 21 is an example of a computer display screen of an example computer file organization of a positioning system;

FIG. 22 is an example of a computer display screen of an example perceptual map information gathering system of a positioning system;

FIG. 23 is an example of a computer display screen of an example set of images of a positioning system;

FIG. 24 is an example of a computer display screen of an example perceptual map information gathering system, including an example of a dimension crossing window; and

FIG. 25 is an example of a computer display screen of an example perceptual map information gathering system of a positioning system.

### DETAILED DESCRIPTION

In the following description, reference is made to the accompanying drawings that form a part hereof and that illustrate a specific embodiment in which the invention may be practiced. It is to be understood that other embodiments may be utilized as changes may be made without departing from the scope of the present invention.

Hardware Environment

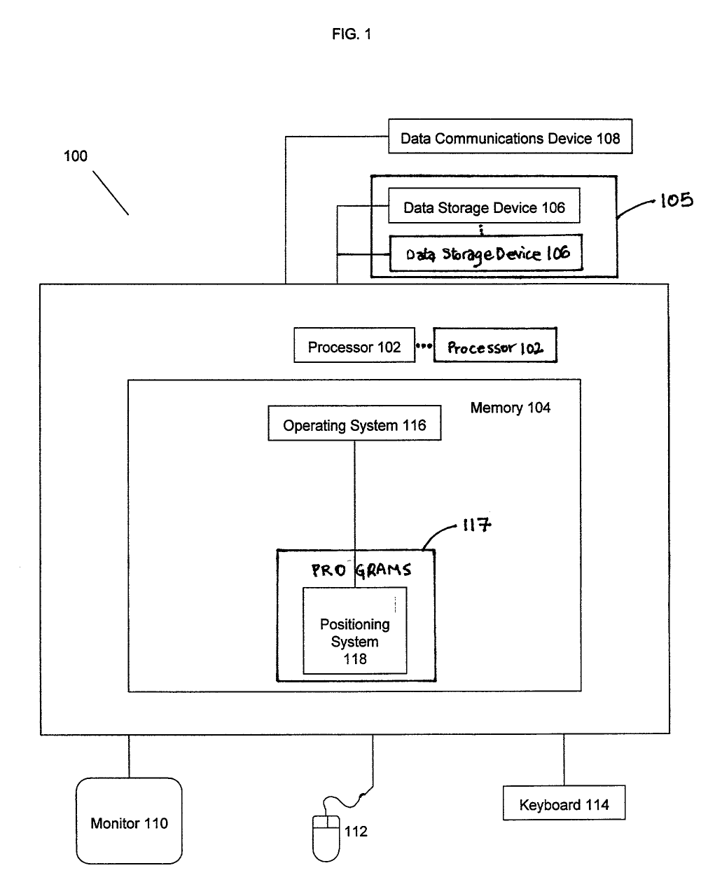

FIG. 1 is a diagram of a hardware environment that may be used to implement an embodiment of the invention. The present invention may be implemented using a computer system 100, which generally includes, inter alia, one or more processors 102, random access memory (RAM) 104, a data storage system 105 including one or more data storage devices 106 (e.g., hard, floppy and/or CD-ROM disk drives, etc.), data communications devices 108 (e.g., modems, network interfaces, etc.), monitor 110 (e.g., CRT, LCD display, etc.), mouse pointing device 112 and keyboard 114. It is envisioned that attached to the computer system 100 may be interfaced with other devices, such as read-only memory (ROM), video card, bus interface, speakers, printers, speech recognition and synthesis devices, virtual reality devices, devices capable of converting a digital stream of bits into olfactory stimuli, taste stimuli, tactile stimuli or any other device adapted and configured to interface with the computer system 100 that is capable of providing an output from the computer system of sensory stimuli representations and capable of converting sensory information into a digital format that is recognizable by the computer system 100 and the like. Those skilled in the art will recognize that any combination of the above components or any number of different components, peripherals and other devices may be used with the computer system 100.

For example, SPEECHWORKS® or NUANCE COMMUNICATIONS® are currently implementing speech technology that allows people to transact business with computers and retrieve information by talking to a machine, either live or via the telephone. Other companies developing speech recognition technology include NORTEL® and LUCENT®. An example of a company that is developing a technology that allows people to interface with computers using sensory information is NCR CORPORATION®. NCR® has developed a prototype allowing Automatic Transaction Machine (ATM) users to transact business with an automatic computerized bank teller machine using biometrics information such as speech recognition and synthesis, iris recognition or retinal scanning technology. These machines may use pressure-sensitive input devices, a keypad touch screen and fingerprint scanning devices, which are well-known to those skilled in the art.

The computer system 100 operates under the control of an operating system (OS) 116, such as WINDOWS NT®, WINDOWS®, OS/2®, MACOS, UNIX®, etc. The operating system 116 is booted into the memory 104 of the computer system 100 for execution when the computer system 100 is powered on or reset. In turn, the operating system 116 then controls the execution of one or more computer programs 117, such as a positioning system 118, by the computer system 100. The present invention is generally implemented in these computer programs 117, which execute under the control of the operating system 116 and cause the computer system 100 to perform the desired functions as described herein. Alternatively, the present invention may be implemented within the operating system 116 itself.

The operating system 116 and computer programs 117 comprises instructions which, when read and executed by the computer system 100, cause the computer system 100 to perform the steps necessary to implement and/or use the present invention. Generally, the operating system 116 and/or computer programs 117 are tangibly embodied in and/or readable from a device, carrier or media such as memory 104, data storage devices 106 and/or a remote device coupled to the computer system 100 via the data communications devices 108. Under control of the operating system 116, the computer programs 117 may be loaded from the memory 104, data storage devices 106 and/or remote devices into the memory 104 of the computer system 100 for use during actual operations.

Thus, the present invention may be implemented as a method, apparatus or article of manufacture using standard programming and/or engineering techniques to produce software, firmware, hardware or any combination thereof. The term “article of manufacture” (or alternatively, “computer program product”) as used herein is intended to encompass a computer program accessible from any computer-readable device, carrier or media. Of course, those skilled in the art will recognize many modifications may be made to this configuration without departing from the scope of the present invention.

Those skilled in the art will recognize that the specific environment illustrated in FIG. 1 is not intended to limit the present invention. Indeed, those skilled in the art will recognize that other alternative hardware environments may be used without departing from the scope of the present invention.

The Positioning System

Positioning system 118 is a computer program that provides a technique for collecting and analyzing information that may be used to create an image or perception for a product or company. In other words, positioning system 118 may be used for creating an ownable identity for a product or company around a set of defined perceptions. In one embodiment, a company wanting to create a particular image of being “fun and exciting,” for example, may use positioning system 118 for collecting information about what users think is “fun and exciting.” Then, positioning system 118 can analyze and process the collected information and provide averages of how consumers rank a particular image, for example. Positioning system 118 can also output or present a desired perception. For example, an image or perception of being “fun and exciting” may be output or presented to consumers in a variety of formats such as visual, auditory, olfactory, taste, tactile and experiential.

Positioning system 118 distills signals and messages that are sent by specific visual, auditory, olfactory, taste, tactile, experiential and other sensory perceivable cues. This enables the user to deliver a more precise translation of a desired message or positioning (e.g., image or perception) for a particular brand or product in the marketplace. Positioning system 118 provides qualitative and quantitative information to its users. The information is collected and processed using computers and is consequently much more efficient than human researchers. Moreover, positioning system 118 adds a degree of depth to the information gathered by processing the collected information and analyzing details such as color, composition, tone and context to discover information that is not discernible to human researchers.

Furthermore, positioning system 118 enables companies to conduct research of their consumers' perceptions globally by using a network of computers, such as the Internet, LANs and the like, which will be discussed further below. By using positioning system 118, a company can quickly react to market situations, shorten the development cycle of marketing and product design programs, and identify demographic, psychographic and technographic trends. Once in use, it is possible that the invention will provide additional opportunities for gathering and analyzing information that will enhance a company's position in the marketplace.

To create a perception or “brand image,” a strategy is created using positioning system 118. To be useful to companies, the strategy is translated into an implementation. The strategy should generally be clear while the implementation should generally be precise. In one embodiment, positioning system 118 is used primarily in the translation process. One skilled in the art, however, would recognize that the concepts of the present invention may be applied to different phases of an image or perception of an image or perception development process and to other processes as well.

Positioning system 118 provides a database that includes a media library and information related to each media within the media library. The media defines the format in which information is captured and populates the database. For example, in one embodiment, the storage device 106 may include a database of still images, video clips, sound clips, virtual reality clips and the like. The information used by positioning system 118 may also be stored as a sequence of bits or information, configured to trigger output devices designed to output or current information. These output devices may include, but not be limited to, those that generate smells, synthesize sounds and produce sensations of taste. Virtual reality output devices are currently being developed by companies such as DIGITAL TECH FRONTIERS that allow users to view, hear and feel the experience of driving a car.

Also, information from a variety of input devices may be presented or input into the computer and converted to the appropriate format for storage in the database. For example, various input devices may be used, such as a conventional keyboard, mouse, touch-pad or touch-screen devices. Furthermore, positioning system 118 may be presented with information read by speech recognition, iris scanning, fingerprint scanning and other input device capable of scanning sensory, biological or biometrics responses from a consumer. Accordingly, any device capable of monitoring sensory, biological or biometrics responses from the consumer and converting such responses to a computer-readable and computer-useable format may be incorporated with positioning system 118. Once the data is converted into a computer-readable format, it may be stored and added to the database.

In one embodiment, the media database may incorporate artificial intelligence, leveraging existing models of fuzzy logic and scalable to support future technical advancements and growth of the media library. Fuzzy logic is a superset of conventional (Boolean) logic that has been developed to monitor and make decisions based on a spectrum of inputs that represent the concept of “partial truth.” For example, fuzzy logic can handle inputs that lie between logical values that are “completely true” and “completely false.” Fuzzy logic may be regarded as a methodology or process of generalizing any specific or discrete theory into a continuous or fuzzy form. Fuzzy logic provides a framework for mirroring the subjective decision-making process and adds a degree of detail (e.g., measuring the density of a specific hue of gold) that is difficult for consumers or researchers to provide because they lack the capacity or resources to measure subjective types of information.

For purposes of illustrating the state of the art in fuzzy logic the following publication are herein incorporated by reference: Zadeh, Lotfi, “Fuzzy Sets,” Information and Control 8:338-353, 1965; Zadeh, Lotfi, “Outline of a New Approach to the Analysis of Complex Systems”, IEEE Trans. on Sys., Man and Cyb. 3, 1973; Zadeh, Lotfi, “The Calculus of Fuzzy Restrictions”, in Fuzzy Sets; and Applications to Cognitive and Decision Making Processes, edited by L. A. Zadeh et. al., Academic Press, New York, 1975, pages 1-39.

For more information on fuzzy logic operators the following publication are herein incorporated by reference: Bandler, W., and Kohout, L. J., “Fuzzy Power Sets and Fuzzy Implication Operators”, Fuzzy Sets and Systems 4:13-30, 1980; and Dubois, Didier, and Prade, H., “A Class of Fuzzy Measures Based on Triangle Inequalities”, Int. J. Gen. Sys. 8.

Furthermore, the artificial intelligence technology provides the ability to develop a database capable of learning. The database is populated with information gathered from consumers, clients, user management groups, online polling groups, secondary research groups and the like (hereinafter user(s)). Furthermore, the term user includes not only a person trained in using the present system but also a third party. A third party includes a person for whom the user or the user's employer is performing perception management. Accordingly, information in the form of sensory stimuli representations are output or presented to the users and any responses to the sensory stimuli representations by the users are captured and stored by the positioning system. The sensory stimuli representations are output, and the users' input may be stored or contained in various media sources and represented in various media types.

For example, as discussed above, the sensory stimuli representations and responses may be stored as visual, auditory, olfactory, taste, tactile, experiential, virtual reality and the like, in the form of digital data populating the database. Furthermore, users' responses may be input from a conventional keyboard or mouse, or in the form of speech, iris scanning, fingerprint scanning and other biometrics data such as sensory, biological or biometrics responses from a user as provided by various input devices that are generally well-known in the art.

The artificial intelligence technology recognizes degrees of relationships between the sensory stimuli representations and the responses to the sensory stimuli representations that may uncover similar characteristics. Accordingly, artificial intelligence extends the most recent appropriate sensory stimuli representations to previously unrelated sensory stimuli representations. As the database grows, the depth of information grows; and, as the relationships between the sensory stimuli representations and responses are recognized, positioning system 118 saves labor-intensive work, such as manually deciding which sensory stimuli representations and responses are related. Artificial intelligence may be used to refine the database of sensory stimuli representations stored in the database.

In one embodiment, positioning system 118 incorporates intelligent agents that are assigned to specific items and perform specific tasks. Intelligent agents technology is an advanced form of artificial intelligence that learns from experience and spawns new generations of “agents” capable of extending their predecessors' knowledge and creating their own solutions to problems. Accordingly, intelligent agents are capable of adapting to their environment, are responsive to existing and newly introduced stimuli and are capable of creating solutions to problems in their environment. Those skilled in the art will appreciate that the technology has been distributed to the public in the form of the video game CREATURES. The technology is currently being used to generate “virtual pilots” and to develop a “virtual bank” that is capable of testing consumers' frustration levels with bank teller responsiveness.

In one embodiment, the present invention provides the use of intelligent agents technology for positioning system 118. For example, an agent may be assigned to each sensory stimuli representations. The agent then searches the database looking for similarities between the assigned sensory stimuli representations and other sensory stimuli representations and any characteristics that may be associated with the sensory stimuli representations. For example, an agent may identify that a specific hue of gold has a 90 percent correlation with notions of being “genuine.” Positioning system 118 can then use the agent to look for all sensory stimuli representations with the identified hue of gold, with, for example, at least 25 percent coverage of the sensory stimuli representations of that hue and adding the descriptor “genuine” to each of those sensory stimuli representations. As the process of identifying similarities repeats itself, the accuracy of associations between a particular set of sensory stimuli representations and other sets of sensory stimuli representations and responses grows. The interactions are analyzed to obtain information from the consumers about their particular perceptions of the company or products based on their interaction with the graphical indicia.

Positioning system 118 may use agents to create concept boards. A concept board is a creative execution that reinforces all of the company's desired perceptions. Because it is subjective in nature, until recent technical advancements, this process required human creativity. The notion of a concept board is not meant to conform the idea around any physical board but to provide an architecture within which the sensory stimuli representations may be organized to best suit the translation process. For example, the “concept board” may be comprised solely of sound.

In one embodiment, the intelligent agent technology may be adapted to develop a group of “virtual positioning strategists,” each with its unique style and thought patterns. Each agent would also have intimate knowledge of every set of sensory stimuli representations and any associated idea or concept related to that particular set of sensory stimuli representations in the database. The virtual positioning strategists would analyze the sensory stimuli representations stored in the database and then attach any other associated stimuli data thereon. For example, the virtual positioning strategists could analyze still images that have been stored in the database and then attach associated keywords and concepts to those images.

Once the analysis by the virtual positioning strategists has been completed, control is passed to an artificial intelligence virtual designer. The virtual designer would have a fundamental knowledge of specific aspects of sensory stimuli representations. For example, knowledge of typography, design layout, color theory and the like. The virtual designers would be capable of automatically creating an interpretation of a set of desired perceptions in the form of a concept board or translation tool. Due to the uniqueness of each intelligent agent, each one could create an entirely different concept board.

The positioning system's 118 database provides several advantages. First, the database can infer information from one set of sensory stimuli representations by cross-referencing its content with the content and information of other sets of sensory stimuli representations stored in the database. The ability to make inferences allows positioning system 118 to select the categories and the sensory stimuli representations for a spectrum of a specific project. For example, if a project is to develop the perception of being “fun and exciting,” positioning system 118 can probe into its database and retrieve sensory stimuli representations that have already been categorized as being “fun and exciting.” Then, the retrieved sensory stimuli representations may be output or presented to users for obtaining their responses regarding which of the retrieved sensory stimuli representations they most closely associate with being “fun and exciting.” The retrieved sensory stimuli representations may be output together (e.g., as a spectrum or ranking) or may be output separately.

Additionally, the ability to make inferences allows a ranking of sensory stimuli representations to be developed on less subjective information, thus eliminating the personal biases an individual may have when manually creating the spectrum. By taking a sensory stimulus representation and translating its content into mathematical and other representations of the information, the database allows a more detailed understanding of each sensory stimulus representation, which will lead to making better judgments regarding which sensory stimuli representations belong to a selected spectrum or ranking.

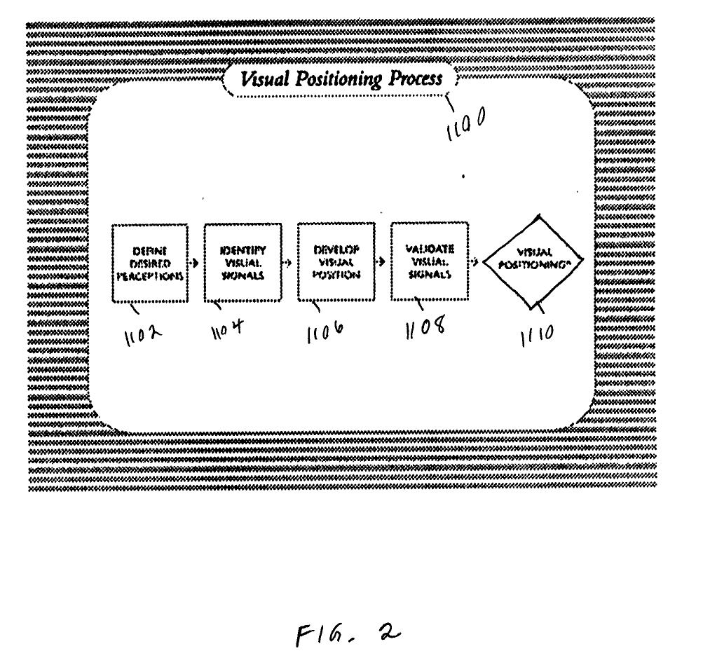

FIG. 2 is a diagram of the steps used in the positioning process 1100 of a perception management system. First, the desired perceptions are defined 1102 or clarified. Then, the signals are identified 1104. A position is developed 1106. The signals and cues are validated 1108. The result is positioning 1110.

The step of defining desired perceptions 1102 identifies the perceptions of both a company and consumers. Generally three to five desired perceptions combine to create a position. For example, a company may be attempting to create an image or perception of being “accessible.” To determine what “accessible” means, positioning system 118 develops a definition of “accessible” using different sensory cues. For example, positioning system 118 may output categories of sensory stimuli representations that represent various images or perceptions for a product or company. Users then match the output sensory stimuli representations they believe are most representative of the perceptions of “accessible.” Additionally, the users would be requested to submit their observations about the output sensory stimuli representations and the rationale for the particular placement they chose. A similar process may be used with a cross-functional team (e.g. marketing, sales, engineering, and the like) of key company employees to determine what sensory stimuli trigger the desired perception of “accessible.”

The process described above may be repeated using many sensory stimuli representations and occurs for each desired perception of a chosen position. Examples of different sensory stimuli representations include: visual sensory stimuli representations such as motion or still pictures, iris recognition or retinal scanning; auditory sensory stimuli representations such as music, sound, synthesized speech and the like; olfactory sensory stimuli representations such as smell; taste sensory stimuli representations; tactile sensory stimuli representations such as touch or feel; experiential sensory stimuli representations based on empirical data; virtual reality type sensory stimuli representations; and any combination of such stimuli representations.

Users may be given access to a number of sensory stimuli representations with positioning system 118 by providing a grouping of sensory stimuli representations selected from a database of sets of sensory stimuli representations, or by providing access to all of the sensory stimuli representations stored in the database. Accordingly, consumers would select the particular sensory stimuli representations that they perceive represent an image or perception of being “accessible.” For example, users may select still photographs of people looking at a camera vs. still photographs of people with their backs turned to the camera. This will assist with collecting information that contributes to the development of a visual definition of an image or perception of being “accessible.” Then, to obtain the rationale for the particular selection made by the user, positioning system 118 may request that users input or present their responses to the system.

For example, users may input a verbal description or representation to positioning system 118. Alternatively, positioning system 118 may provide a list of words from which the users can select words to provide a response. It will be appreciated that the present invention may use any means for entering or presenting information to positioning system 118, including a keyboard, mouse, a speech-to-text conversion device and the like. Users' responses will assist in defining an image or perception of being “accessible” more accurately. For example, being “accessible” may be defined more precisely as being “genuine and approachable.” Again, the process may be repeated using many sensory stimuli representations, as discussed above.

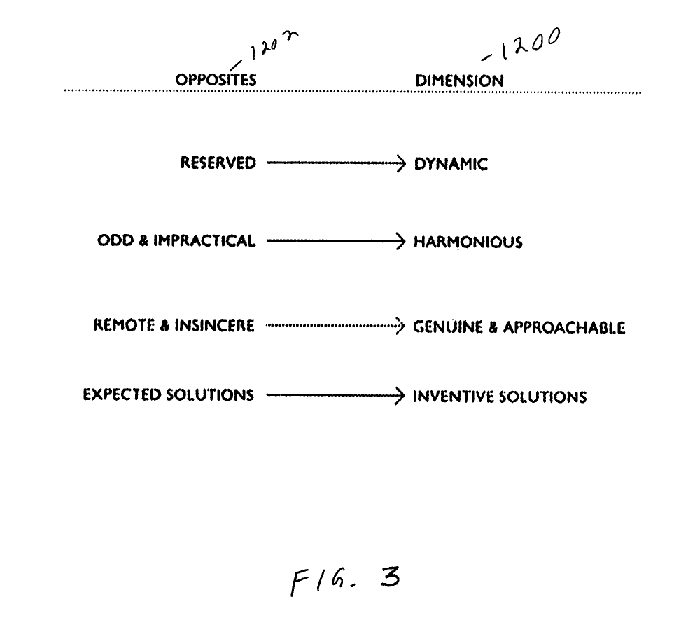

The next step in defining a desired image or perception 1102 is to develop a chart of desired perception (dimension) opposites. After each of the three to five desired perceptions are chosen, an opposite for each is developed. FIG. 3 is a diagram of dimensions 1200 and their opposites 1202. The opposites of these dimensions are provided to clarify which elements and perceptions should be avoided when translating the chosen position.

For example, a company may attempt to create an image or perception of being “fun.” Company employees may undergo the same exercises described above as the users. In doing so, the employees will develop a consensus regarding what sensory stimuli representations are output by the positioning they believe connotes the image or perception of being “fun.” After the images or perceptions are developed and there is a recognized perceptual disconnect between the company and the users, positioning system 118 translates the chosen image or perception into a more appropriate definition for the target audience. For example, the image or perception of “fun” may become an image or perception of “engaging vitality.”

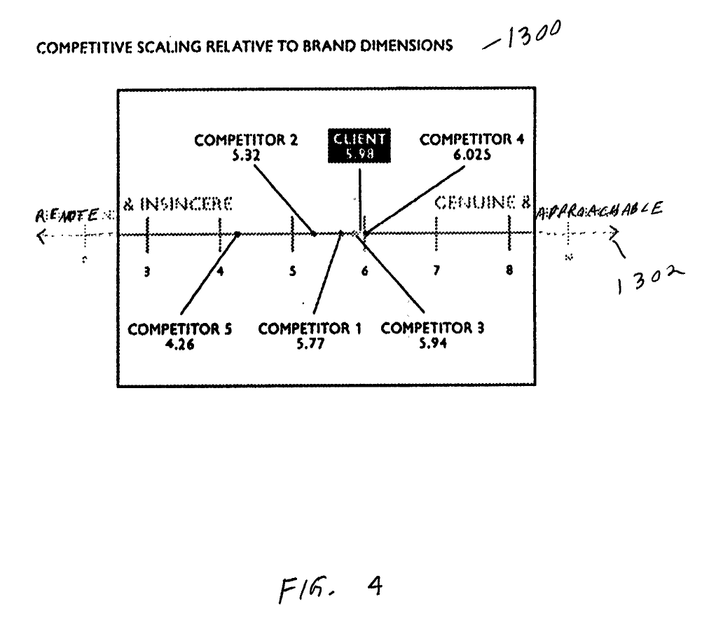

Positioning system 118 may also collect information to develop a competitive scale that indicates the company's current image or perception relative to its desired image or perception and that of its competition. FIG. 4 is a diagram illustrating a competitive scaling relative to brand dimensions (the desired perceptions) 1300. For example, positioning system 118 will display a scale 1302 based on the desired perception and its opposite. In one such example, the opposite is “remote and insincere” and the desired perception is “genuine and approachable.” Users may then be asked to rank the company that is attempting to position its image or perception against its competitors along the same scale. This ranking will identify whether the perceptions they wish to own are indeed ownable with their particular target audience. For instance, if a competitor ranks high on a particular desired perception it may indicate that it will be difficult to own that perception.

In the second step in the positioning process 1100, positioning system 118 assists in identifying signals 1104 and cues that send the desired perceptions. At this point, positioning system 118 may be used to capture the placement of sensory stimuli representations by users along with their responses and the rationale for selecting their particular placements. The information typically is captured from a number of users and then processed to provide a statistical reference that demonstrates the overall results of a specific set of images or perceptions. The representations typically are captured for each sensory stimulus representation and for the desired perception and its opposite along a linear spectrum. Positioning system 118 recognizes the placement or ranking of each image or perception. For example, a sensory stimulus representation that is placed three images from the right is coded as three. If there are eight sensory stimuli representations to be placed, the second sensory stimulus representation from the left would be coded as seven. Observations specific to a sensory stimulus representation representative of an image or perception may be captured in text edit fields located below the specific sensory stimulus representation that is output and its calculated numeric fields. The calculated numeric fields include averages of where the sensory stimulus representation was placed by different users.

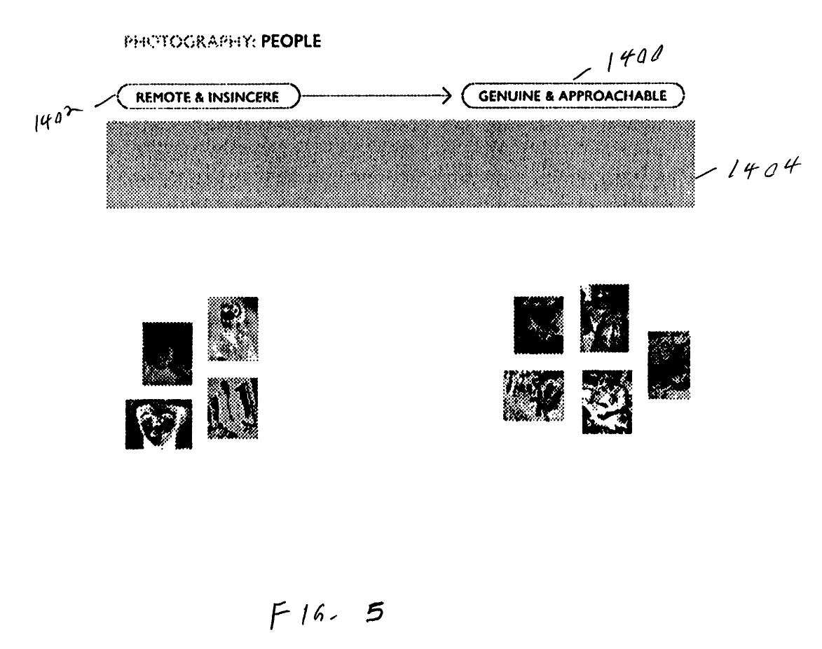

FIG. 5 is a diagram illustrating a display provided by positioning system 118 for categorizing and ranking sensory stimuli representations that are representative of various images or perceptions. Positioning system 118 displays one of the dimensions, such as being “genuine and approachable” 1400 and its opposite, such as “remote and insincere” 1402. The dimension 1400 and its opposite 1402 are disposed linearly from each other, with an arrow between them. The arrow represents a linear scale from one dimension to the other. Additionally, a sensory stimuli representations ranking area 1404 is displayed below the arrow where users may place and rank the sensory stimuli representations from an area below the dimension toward an area representing its opposite. This process categorizes and ranks the sensory stimuli representations. Users may drag the sensory stimuli representations to desired locations in the ranking area 1404.

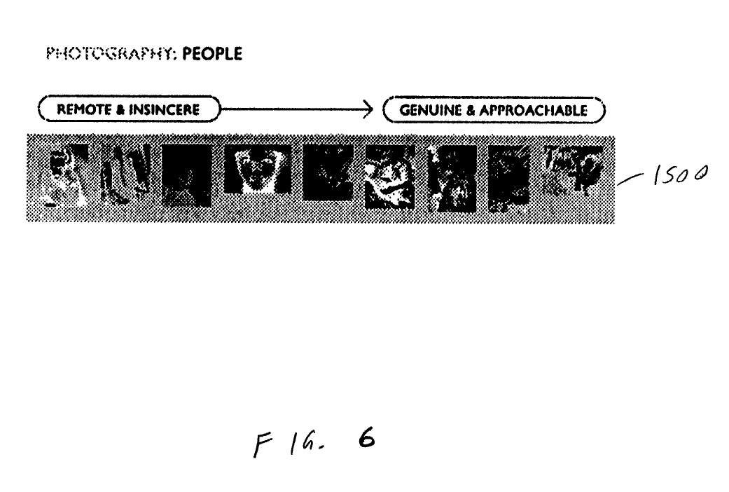

FIG. 6 illustrates a display provided by positioning system 118 for categorizing and ranking sensory stimuli representations. A user is able to place a sensory stimulus representation in a block below the dimension and its opposite by moving (e.g., dragging) the sensory stimulus representation with a pointing device such as a mouse or touch panel display. The user places the sensory stimuli representations in an order 1500 that ranks them from being most representative of an image or perception of being “remote and insincere” to being most representative of an image or perception of being “genuine and approachable.”

In one embodiment of the invention, positioning system 118 outputs to the users several sensory stimuli representations and queries the users to sort the sensory stimuli representations or place them in a linear order (e.g., a sequential ranking). The sensory stimuli representations within the spectrum may be small in size. For some sensory stimuli representations, in which there are many details, this technique may not be useful, as the details may be lost due to the size of the sensory stimuli representations on an output device (e.g., a very small visual image displayed on a monitor). In contrast, with some simple types of sensory stimuli representations, this technique allows users to view all related sensory stimuli representations at once, thus making ranking the sensory stimuli representations easier for the user.

In one embodiment, positioning system 118 outputs or presents to the users sensory stimuli representations one at a time or a few at a time so the particular sensory stimuli representations may be output with adequate details to be representative of the sensory stimuli representations. Users are then asked to provide or input a response (feedback) to positioning system 118 regarding the sensory stimulus representation or sensory stimuli representations shown. For example, users may provide a ranking for each sensory stimuli representations. This method gathers information independent of a spectrum or ranking without exposing the consumer to the spectrum or ranking.

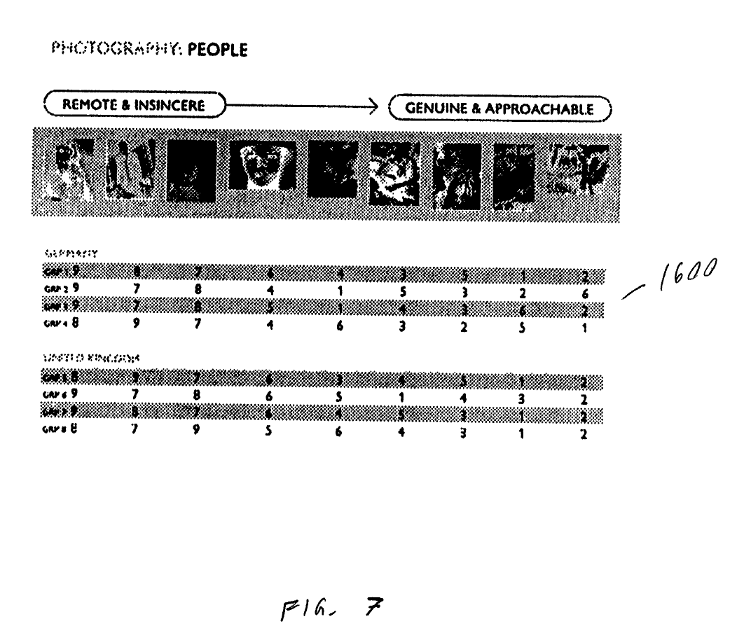

FIG. 7 is a diagram illustrating the aggregate results provided by positioning system 118 after processing information received from consumers. In particular, positioning system 118 recognizes where the sensory stimuli representations are placed by the users within the ranking. Positioning system 118 is also able to obtain this information from many users in many research groups or individual testing sessions. Then, positioning system 118 may provide the results 1600 obtained from processing the collected responses regarding the sensory stimuli representations from the consumer's input as a whole. For example, averages of rankings may be calculated and output. Furthermore, rankings may be output by different testing category (e.g., by country or demographic breakdown), thus providing an indication of how different categories of users rank differently.

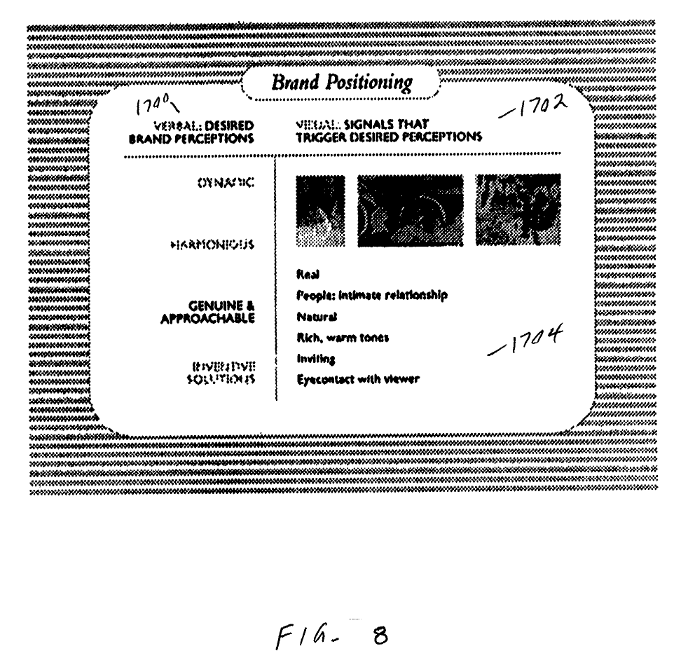

FIG. 8 is a diagram illustrating the results of the collected information after processing by positioning system 118. Positioning system 118 may receive information from many sources. For example, information may be obtained from users associating a dimension with one or more sensory stimuli representations and subsequently associating each sensory stimulus representation with the particular representation for that sensory stimulus representation. Then, positioning system 118 may output a list of desired images or perceptions 1700. For example, when a consumer selects an image or sensory stimuli as being “genuine and approachable,” positioning system 118 captures that users representations and rationale from the consumer and identifies and recognizes associated signals that trigger those desired perceptions.

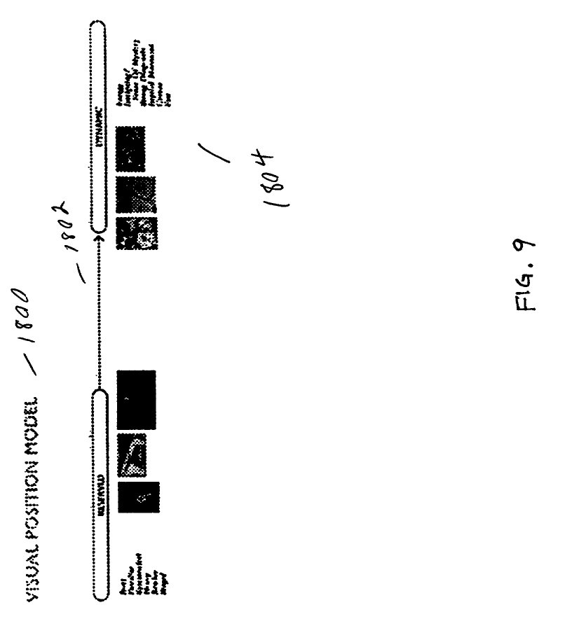

Once the signals and cues for the desired image or perception have been identified, the next step in the translation process for developing an appropriate position (e.g., image or perception of a product or company), is developing a position 1106. FIG. 9 is a diagram of a position model 1800. The position model 1800 illustrates a refined summary of sensory stimuli and associated representations for both the desired image or perception and its opposite. Although only one linear scale 1802 is illustrated, one skilled in the art would recognize that many other summaries may be displayed with sensory stimuli representations and associated responses.

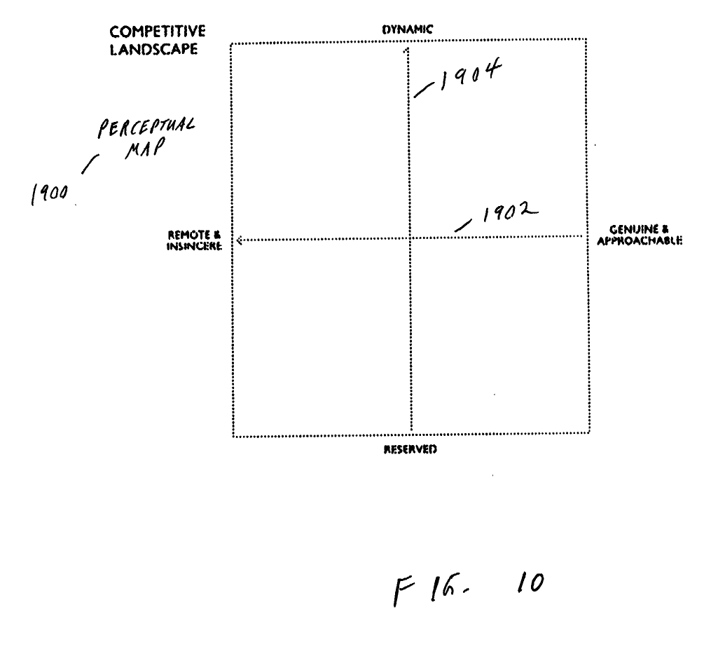

The next step in the positioning process 1100 for developing a brand image or perception is to validate the signals 1108. FIG. 10 is a diagram of a perceptual map 1900 output by positioning system 118. Positioning system 118 displays the perceptual map 1900 with an x axis 1902 and a y axis 1904 that intersect to form a grid. Each axis 1902, 1904 represents a range between a dimension and its opposite. For example, the x axis 1902 represents a range between an image or perception being “remote and insincere” and an image or perception being “genuine and approachable.” The y axis 1904 represents a range from “reserved” to “dynamic.” Positioning system 118 provides users with various forms of sensory stimuli representations (e.g., images that can be placed onto the perceptual map 1900).

Alternatively, positioning system 118 provides users with other forms of sensory stimuli representations (e.g., labels such as unique numbers that represent the sensory stimuli representations), and the users place the labels on the perceptual map 1900. For example, if 12 sensory stimuli representations are to be placed on the perceptual map 1900, they may be numbered 1 to 12 and randomly sequenced. Users use positioning system 118 to place the sensory stimulus representation's numbers in its approximate location of the perception map. When all sensory stimuli representations have been placed, the perception system 118 captures the x and y coordinates of each sensory stimulus representation.

As multiple users are separately placing sensory stimuli representations on the perceptual maps 1900, positioning system 118 can take their placement as input to develop a perceptual map 1900 with a calculated “average” placement. This may be done, for example, by averaging the x and y coordinates for each sensory stimulus representation on each perceptual map 1900. For example, the dimensions “genuine and approachable” and “dynamic” may be tested with eight focus groups each completing a perceptual map for those dimensions. Positioning system 118 will calculate the average placement of the sensory stimuli representations from all of the focus groups.

Positioning system 118 uses the perceptual map 1900 to validate the translation process to date and to measure the translation process against current competitive examples or executions in the marketplace. The perceptual map 1900 is also used to measure the effectiveness of creative implementation vs. a competitive implementation. As such, users place sensory stimuli representations from the creative implementation generated by positioning system 118 and sensory stimuli representations from the competitor's implementation on the perceptual map 1900. If the (Rewrite) sensory stimuli representations from the process performed by positioning system 118 are positioned closer to the desired image or perception than the competitor's sensory stimuli representations, then the positioning system's 118 processed results are validated. Once the translation process is complete, the result is a positioning statement 1110. Accordingly, a creative platform is ready, a positioning expression is developed and a positioning manual is prepared.

In one embodiment of the invention, positioning system 118 is used via a network, such as the Internet, a LAN and the like. In the recent past, use of computers in both the home and office has become widespread. The computers provide a high level of functionality to many people. Additionally, the computers are typically coupled to other computers via some type of network arrangement, such as the Internet and the World Wide Web (also known as “WWW” or the “Web”). Therefore, users transmit information between computers with increasing frequency.

The Internet is a collection of computer networks that exchange information via Transmission Control Protocol/Internet Protocol (“TCP/IP”). The Internet consists of many Internet networks, each of which is a single network that uses the TCP/IP protocol suite. Currently, the use of the Internet for commercial and noncommercial applications is exploding. Internet networks enable many users at different locations to access information stored in databases at different locations.

The World Wide Web is a facility of the Internet that links documents stored on separate servers throughout the network. The Web is a hypertext information and communication system used on Internet computer networks with data communications operating according to a client/server model. Generally, Web clients request data that is stored in databases from Web servers. The Web servers are coupled to the databases. The Web servers retrieve the data and transmit it to the clients. With the fast-growing popularity of the Internet and the Web, there is also a fast-growing demand for Web access to various databases.

The Web operates using the HyperText Transfer Protocol (HTTP) and the HyperText Markup Language (HTML). The protocol and language results in the communication and display of graphical information that incorporates hyperlinks (also called “links”). Hyperlinks are network addresses that are embedded in a word, phrase, icon or picture and are activated when the user selects a highlighted item displayed in the graphical information. HTTP is the protocol used by Web clients and Web servers to communicate between themselves using hyperlinks. HTML is the language used by Web servers to create and connect together documents that contain these hyperlinks. Those skilled in the art would recognize that the languages used to communicate over the Web are varied and include, in addition to HTML, Java, Javascript, CGI scripts, Perl scripts, Macromedia® Shockwave and Flash file formats, Microsoft Active X applets, Real Audio streaming technologies, Apple's Quicktime and many more. Those skilled in the art would also recognize that new languages and distribution of information are continuously evolving on the Web.

The Internet and the Web have captured the public imagination as the so-called “information superhighway.” Accessing information located throughout the Web has become known by the metaphorical term “surfing the Web.” The Internet is not a single network, nor does it have a single owner or controller. Rather, the Internet is a collection of many different networks, public and private, big and small, whose human operators have agreed to connect to one another.

The composite network represented by these networks does not rely on a single transmission medium. Rather, bi-directional communication may occur via satellite links, fiber-optic trunk lines, phone lines, cable TV wires and local radio links. However, no other communication medium is quite as ubiquitous or easy to access as the telephone network. The number of Web users has exploded, largely due to the convenience of accessing the Internet by coupling home computers to the telephone network through modems.

So far, the Web has been used in industry predominately as a means of communication, advertisement and placement of orders. The Web facilitates user access to information resources by allowing the user to jump from one Web page or server to another simply by selecting a highlighted word, picture or icon (a program object representation) that is representative of information the user wants. The hyperlink is the programming construct that makes this maneuver possible.

To explore the Web today, a user loads a special navigation program, called a “Web browser,” onto a computer. The browser is a program that is particularly tailored for facilitating user requests for Web pages by implementing hyperlinks in a graphical environment. If a word or phrase that appears on a Web page is configured as a hyperlink to another Web page, the word or phrase is generally underlined, represented in a color that contrasts with the surrounding text or background, or otherwise highlighted. Accordingly, the word or phrase defines a region on the graphical representation of the Web page. Inside the region, a mouse click will activate the hyperlink, request a download of the linked-to page and display the page when it is downloaded.

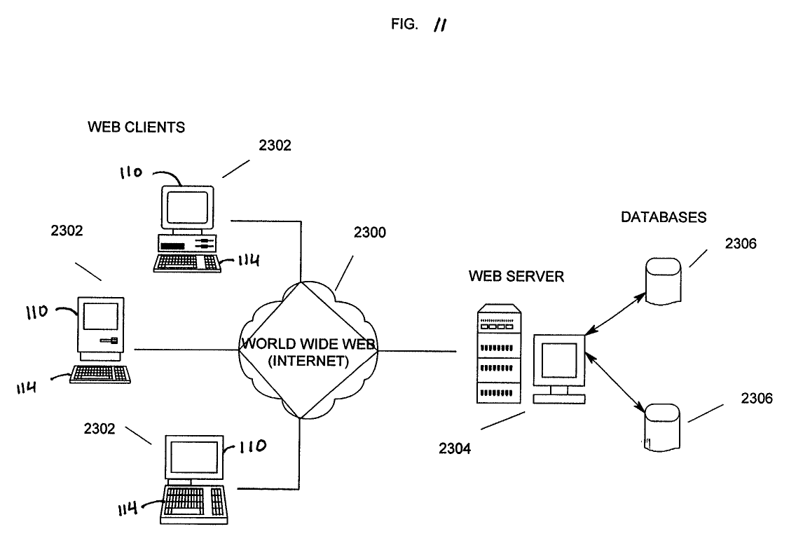

FIG. 11 is a diagram of a hardware environment used to implement one embodiment of the invention within a network architecture and, more particularly, illustrates a typical distributed computer system using the Internet 2300 to connect client computers (or terminals) 2302 executing Web browsers on different platforms to Web server computers 2304, executing Web daemons and to connect the server system 2304 to databases 2306. Generally, a combination of resources may include client computers 2302 that are personal computers or workstations and a Web server computer 2304 that is a personal computer, workstation, minicomputer or mainframe. These systems may be coupled to one another by various networks, including LANs, WANs, SNA networks and the Internet.

Each client computer 2302 executes visual positioning system 118. Additionally, each client computer 2302 generally executes a Web browser and is coupled to a Web server computer 2304 executing Web server software. The Web browser is typically a program such as Microsoft's Internet Explorer® or NetScape®. Each client computer 2302 is bi-directionally coupled with the Web server computer 2304 over a physical line or a wireless system. In turn, the Web server computer 2304 is bi-directionally coupled with databases 2306. The databases 2306 may be geographically distributed throughput the network. Those skilled in the art will recognize many modifications may be made to this configuration without departing from the scope of the current invention.

When providing positioning system 118 across a network, positioning system 118 stores information about users who may be polled (e.g., via a virtual focus group). The information may be stored in one of the databases 2306. Positioning system 118 may search the stored information to identify users who should be polled about particular products or companies. Positioning system 118 can also automatically invite the identified users to participate in a poll.

After selecting and inviting members to join a “virtual focus group,” positioning system 118 collects information from the members of the research focus group using the techniques discussed above. For example, information may be collected by sorting sensory stimuli representations into groups, ranking sensory stimuli representations or preparing a perceptual map. Once the information is collected, positioning system 118 analyzes the information to determine average rankings for sensory stimuli representations, for example. Also, using the collected information, positioning system 118 associates a dimension with one or more sensory stimuli representations and associating each sensory stimulus representation with textual rationales or key concepts.

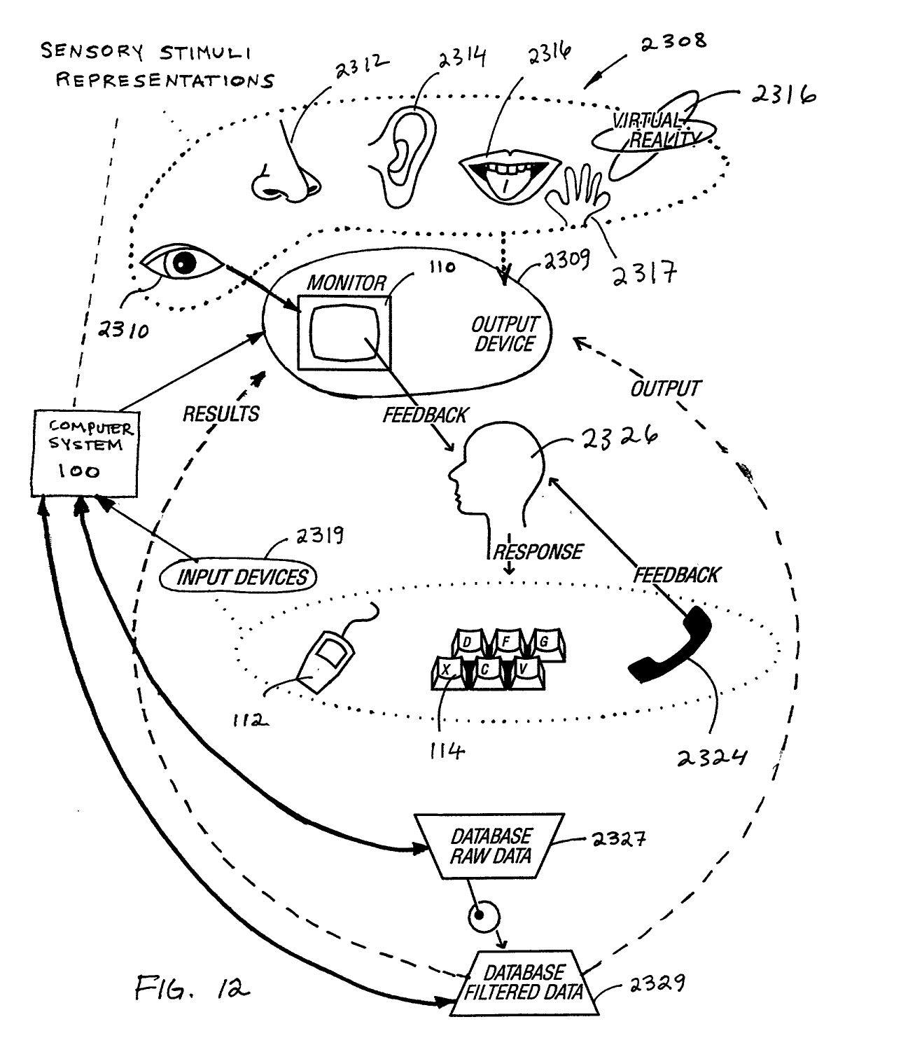

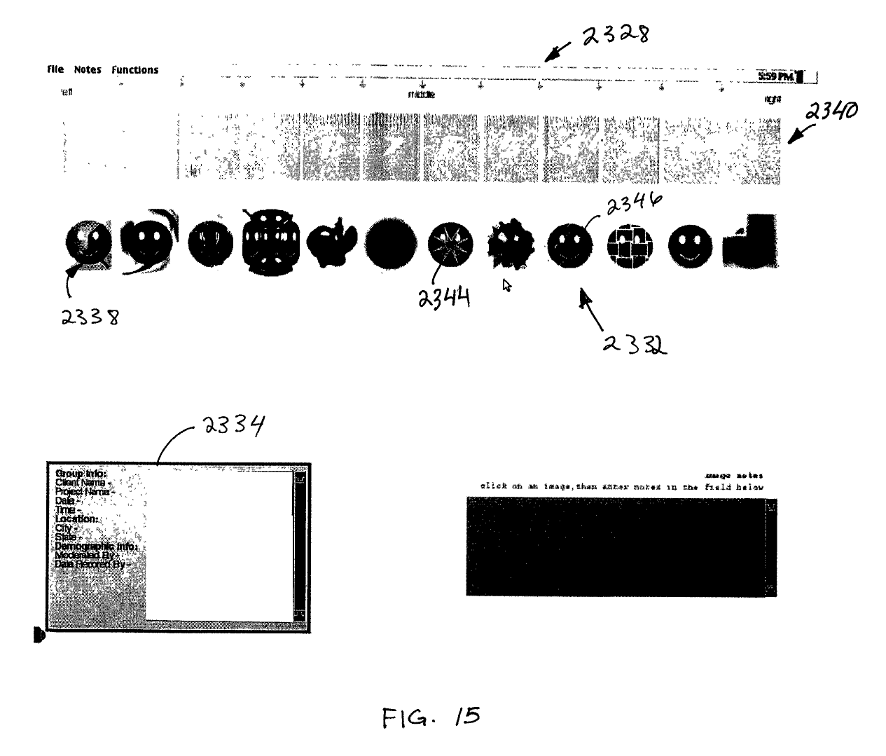

FIG. 12 illustrates a flow diagram of a positioning system 118. The positioning system may use various modes of presenting or outputting from the computer system 100 sensory stimuli representations 2308 to a consumer 2326. For example, positioning system 118 may use various output devices 2308, including outputting visual representations 2310 (FIG. 15) on various output devices 2309 such as a computer monitor 110; olfactory type output devices 2312; audible type output devices 2314; synthetic speech type output devices 2316; virtual reality type output devices 2316; tactile output devices 2317 and the like. The consumer 2326 responds to the sensory stimuli representations and may input his or her response to positioning system 118 via a conventional mouse 112, keyboard 114 or telephone 2324. It will be appreciated by those skilled in the art that the visual representations include one or more elements that embody cues. When viewed by human, these cues send signals to the viewer that influence human behavior by synergistically triggering a desired perception from the viewer.

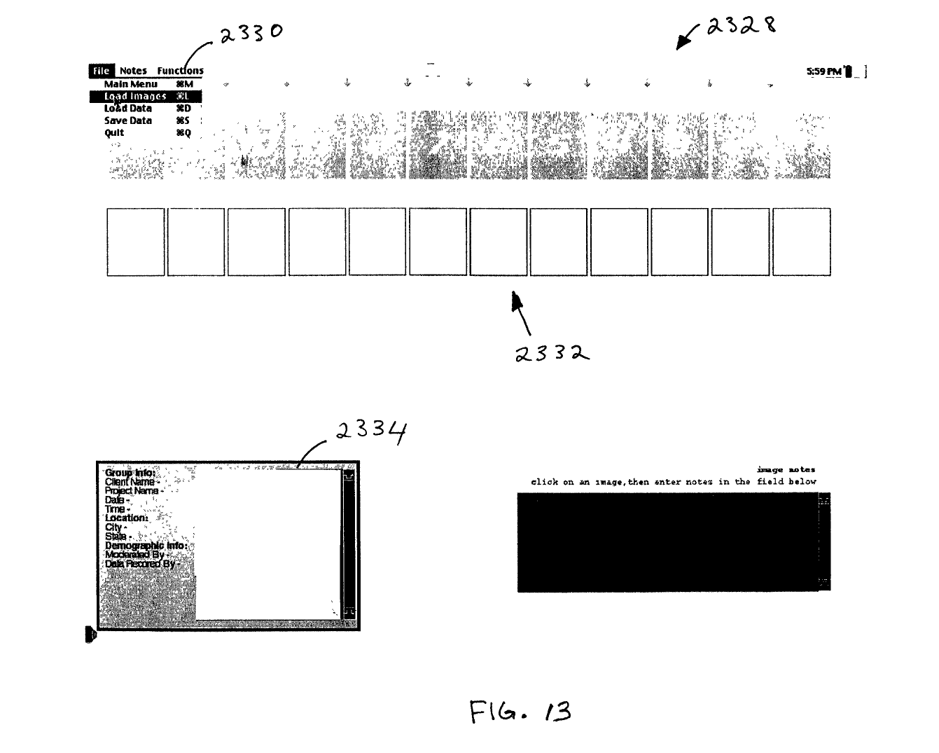

FIG. 13 is a specific display screen 2328 of a software implementation of positioning system 118. The sensory stimuli representations are loaded in the array 2332 (shown empty), allowing the consumer to sort the sensory stimuli representations into spectrums. Users fill out the appropriate information in the box 2334 at the lower left corner of the display screen 2328. Finally, a group of sensory stimuli representations to be sorted are loaded from a spectrum using the file pull-down menu 2330.

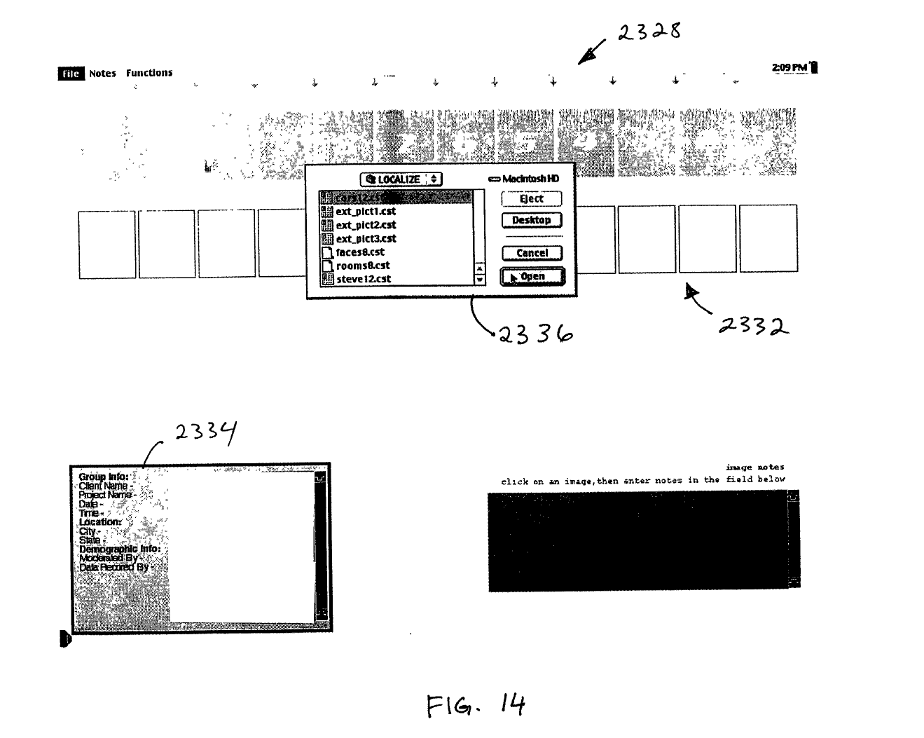

FIG. 14 illustrates the display screen 2328 after selecting “load images” from the file pull-down menu 2330. Accordingly, a dialogue box 2336 appears on the display screen 2328 directing the consumer to choose the specific set of sensory stimuli representations that are to be tested. For example, the sensory stimuli representations to be tested may be a set of visual representations. The sets are organized by dimension and then by category.

FIG. 15 illustrates a specific set of sensory stimuli representations loaded in the array 2332. In the specific display screen 2328, the sensory stimuli representations are a set of visual representations 2338. Once the appropriate set of visual representations 2338 are selected, they are displayed on an output device such as a monitor 110 and are ready to be dragged into the location chosen by the consumer or focus group using, for example, a mouse 112. Each visual representations 2338 is dragged to one of the numbered boxes of the scale 2340 located above the initial array 2332.

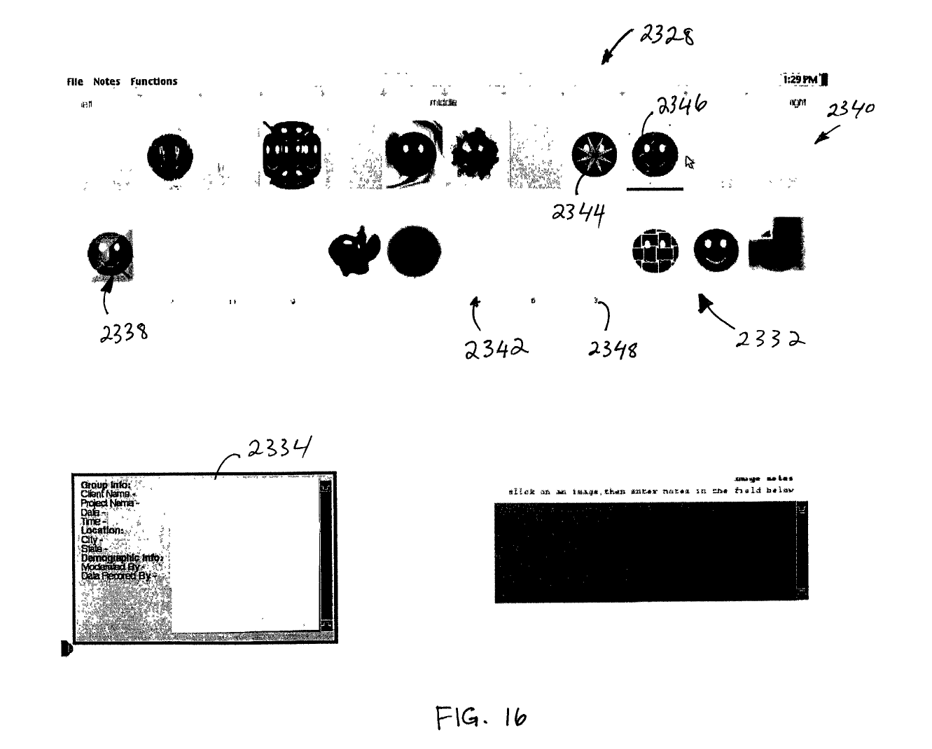

FIG. 16 illustrates the ranking as it is occurring. The location that visual representation 2344 was placed in is noted, in red type, below the original location of the visual representation 2342. For example, visual representation 2346 was originally loaded arbitrarily as the fourth visual representation from the right. The consumer then dragged the visual representation into box number three of the scale 2340 as indicated at 2348. When visual representation 2346 is dragged into position three of the scale 2340, the database registers the placement of visual representation 2346 in box number three and stores that for this particular consumer or focus group. Subsequent users or focus groups may place the visual representation higher or lower on this particular scale 2340. The database maintains a record of each of the placement of this particular visual representation 2346 for each focus group tested. Positioning system 118 will then calculate the average placement of the visual representation 2346 across all focus groups.

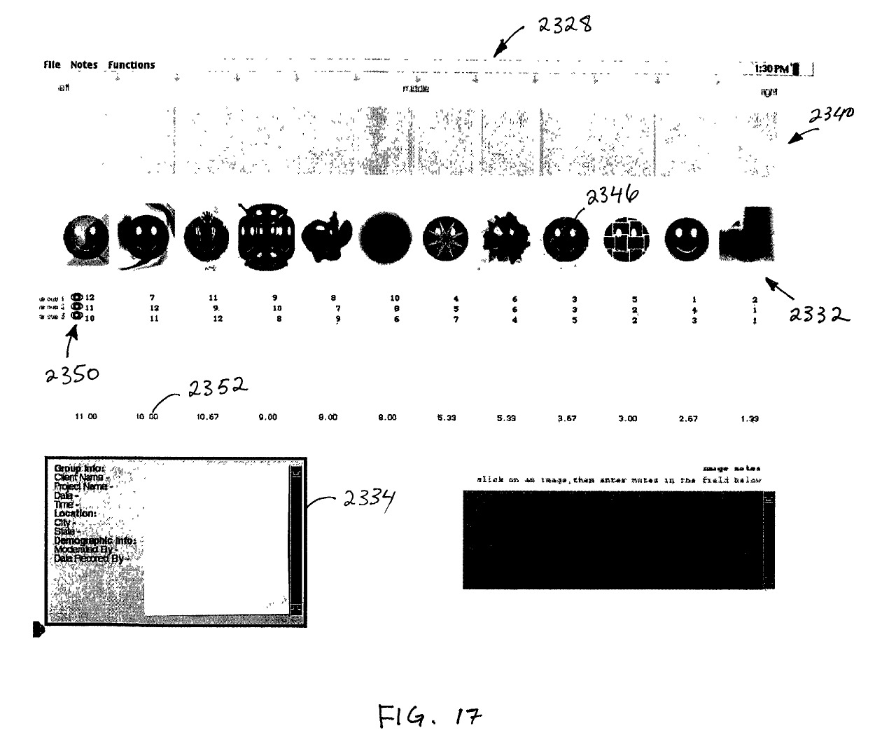

FIG. 17 illustrates the results per group. Placing the mouse over one of the groups 2350 and clicking will display the visual representations in scale 2340 according to the way that particular group sorted the visual representations. The average placement 2352 determined by the different focus groups 2350 are also shown. In this display screen, group 2 has placed visual representation 2346 in the fourth position of scale 2340.

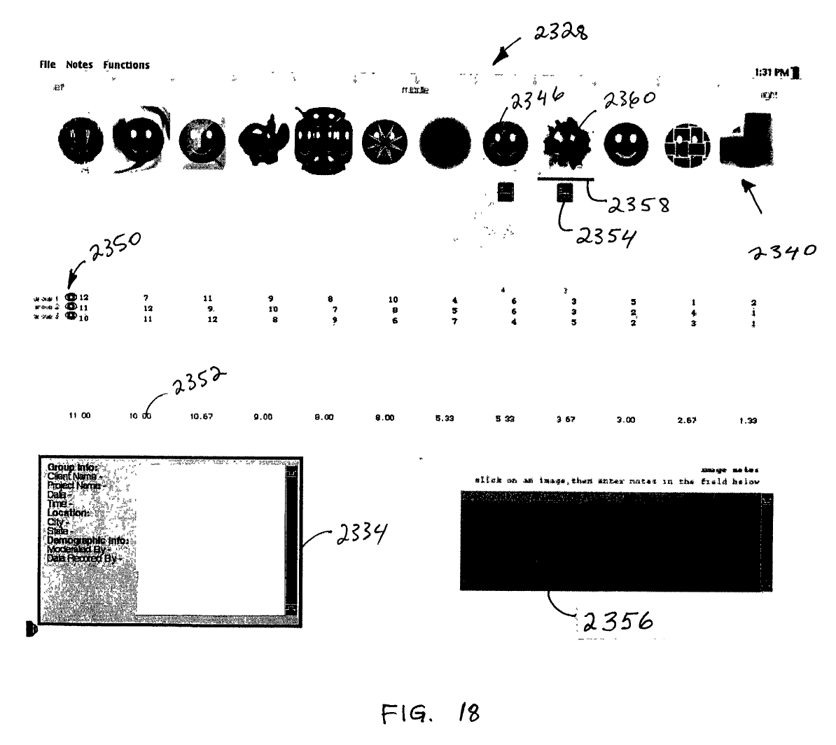

FIG. 18 illustrates visual cue 2358 (e.g., a colored band) that is displayed below the visual representation whenever that visual representation is clicked on. For example, here visual representation 2360 was clicked on and visual cue 2354 is displayed beneath visual representation 2360. When visual representation 2360 is highlighted and clicked on, any observations (e.g., the rational used by the particular consumer or focus group for placement) can be keyed into gray box 2356 at the lower right side of display screen 2328. The information displayed in gray box 2356 is specific to the visual representation currently being highlighted or selected. Also, small icon 2354 appearing below visual representation 2360 tells the user that representation 2360 has had observations recorded. To view the observations, the user need only click on icon 2354.

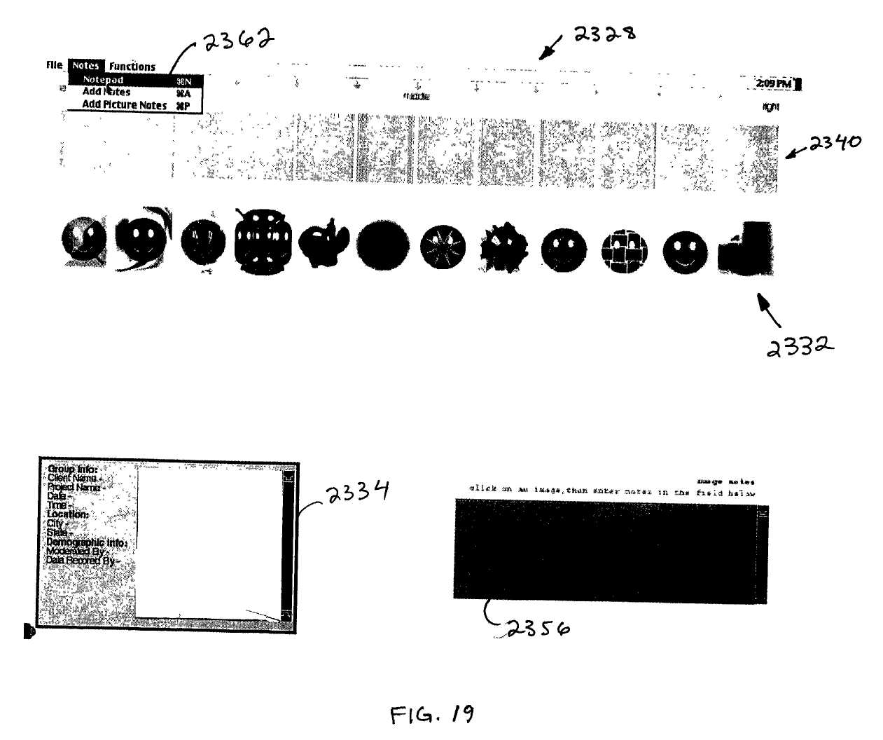

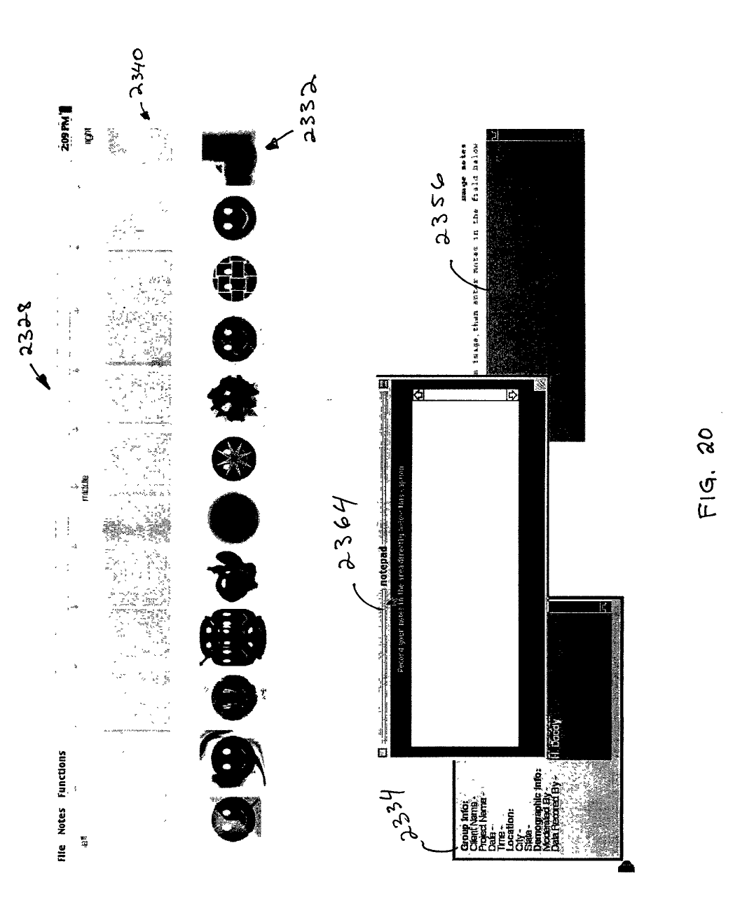

In addition to capturing information in gray box 2356, it is possible to launch a notepad and capture more general information about a spectrum, set of visual representations or a particular focus group. To launch the notepad, the user moves the cursor to the “Notes” drop-down menu 2362 (FIG. 19) on the menu bar, clicks on the menu and then chooses the “Notepad” option. Accordingly, the notepad that is specific to the focus group and visual representation set will be launched and notepad window 2364 (FIG. 20) will be displayed.

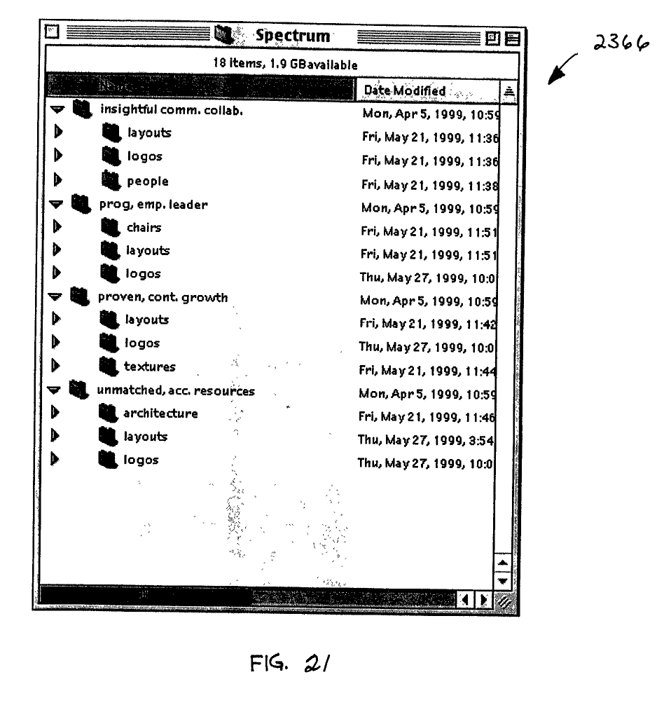

FIG. 21 illustrates display screen 2366, one method in which sensory stimuli representations files (e.g., visual representations) will be ranked.

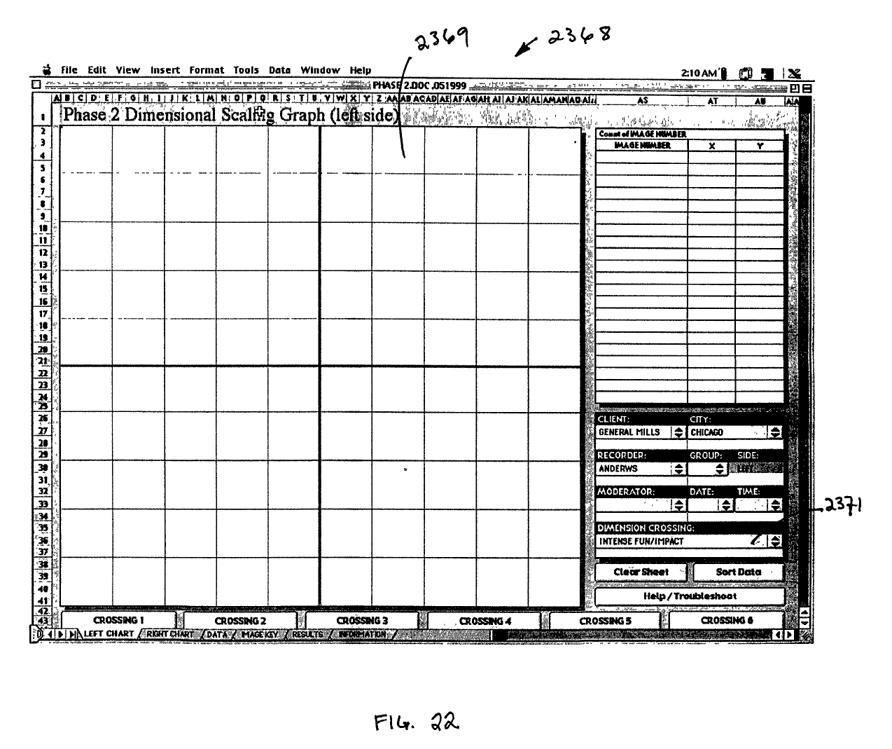

FIG. 22 illustrates display screen 2368 of a perceptual map information gathering tool. The tool is used to track the placement of a creative concept against competitive implementations and across each different cross-section of dimensions. It is used at each research testing group, and then the aggregate results of every research group are averaged and a perceptual map is created on scaling graph 2369 to show the average placement of each tested sensory stimuli representations (e.g., visual representation). Dimension crossing menu 2371 is provided for the user to enter specific information to the group.

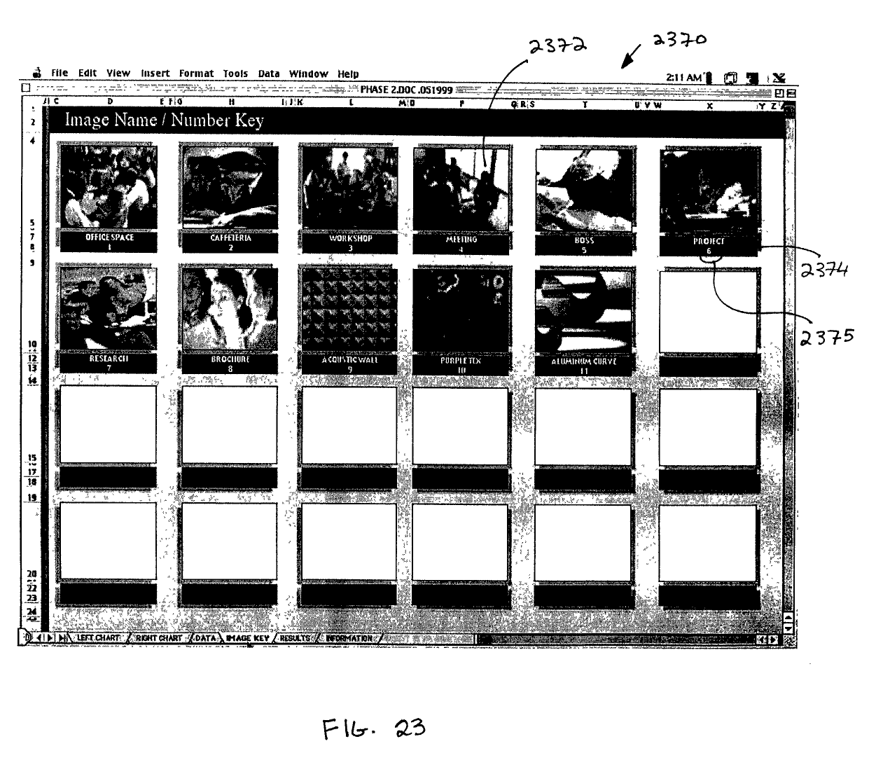

FIG. 23 is display screen 2370, which illustrates how the specific sensory stimuli representations being tested are imported into the file. For example, visual representations 2372 are titled 2374 based on file name and are provided arbitrary number 2375.

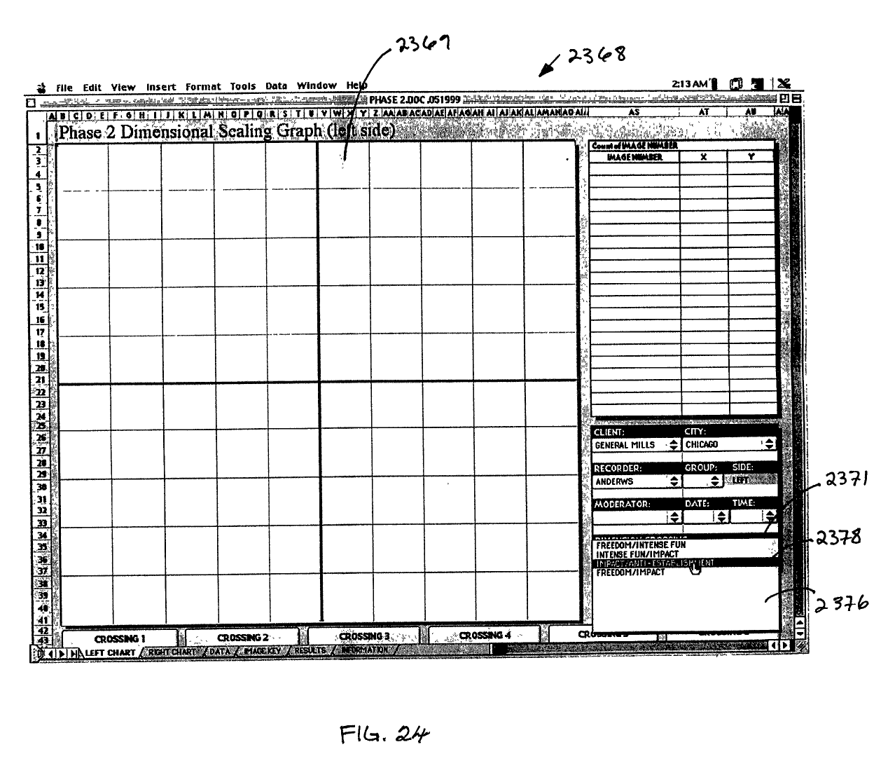

FIG. 24 illustrates display screen 2368 with scaling graph 2369. Before recording the research group's observations or responses to the sensory stimuli representations, the user will generally enter specific information to the group. This is accomplished by clicking on dimension crossing menu 2371 and selecting dimension crossing 2378 that the group is currently testing from dimension crossing window 2376.

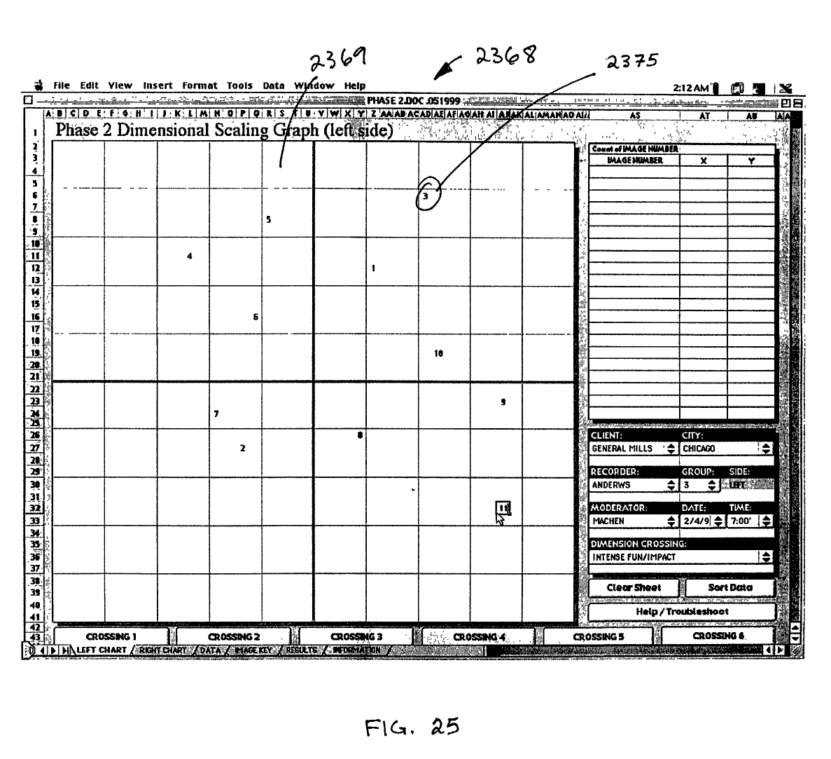

FIG. 25 illustrates display screen 2368 with scaling graph 2369. In scaling graph 2369, the sensory stimuli representations (e.g., visual representations) have been assigned number 2380. Once number 2380 has been assigned, the research groups place visual representations 2374 (not shown) on a physical or electronic perceptual map. The user then places the visual representation's assigned number 2375 in roughly the same location that the research group placed it on the perceptual map.

As alternative embodiments for accomplishing the current invention, any type of computer, such as a mainframe, minicomputer or personal computer or computer configuration, such as a timesharing mainframe, local area network or stand-alone personal computer, could be used with the present invention.

Although the foregoing description of the preferred embodiment of the invention has been presented for the purposes of illustration and description the invention may be embodied in several forms.

For example, referring to FIGS. 1 and 12, one aspect of the present invention provides a method for performing, on a computer system 100 having one or more processors 102, perception management using a plurality of visual representations 2310 stored in a database 2327. The one or more processors 102 and the database 2327 being coupled to the computer system 100. The representations 2310 include one or more particular visual representations 2338 as well as one or more other visual representations. Each visual representation 2310 embodies cues, whereupon viewing by humans, these related cues send signals that influence human behavior by synergistically triggering desired perceptions.

The method includes outputting from the computer system 100 to a user 2326 one or more of the particular visual representations 2338 on an output device 110 coupled to the computer system 100. Classification information for the one or more outputted particular visual representations 2338 is then received from the user 2326 using an input device 114 coupled to the one or more processors 102 in the computer system 100. The method also includes storing the classification information received from the user 2326 for the one or more outputted particular visual representations 2338 in the database 2327. Then, by cross-referencing through access to the database 2327 the received classification information for one or more of the outputted particular visual representations 2338 with the classification information for one or more of the other visual representations, the received classification information for one or more of the visual representations 2310 is distilled in order to identify the related cues that influence human behavior.

Then, the received classification information of one or more of the outputted particular visual representations 2338 is distilled in order to identify the related cues from any one of one or more of the plurality of visual representations 2310. The distilled cues relating to any determined one or more of the visual representations 2310, including one or more of the outputted particular visual representations 2338 or one or more of the other visual representations.

Also, the received classification information of one or more of the outputted particular visual representations 2338 includes classification information of one or more elements of the outputted particular visual representations 2338 and the distilled cues relate to any determined one or more of the elements within one or more of the plurality of the visual representations 2310. A database 2327 of a plurality of visual representations 2310, whereby the outputted visual representations 2338 and associated cues, send signals to the user 2326 to synergistically trigger desired perceptions from the user 2326 may also be created. The database of one or more of the plurality of visual representations 2310 may be created by the user 2326 or a third party. Each visual representation 2310 in the database 2327 is associated with an agent that identifies relationships between the particular visual representation 2338 and the other visual representations stored in the database 2327.

Referring to FIGS. 15-20, classification information of the outputted particular visual representations 2338 is rated and the ratings are then processed to determine an average rating 2352 for each outputted visual representation 2338. Also, the ratings of the classification information may be processed to identify a ranking of one or more of the outputted visual representations 2338.

Responses from the user 2326 related to one or more of the outputted particular visual representations 2338 are captured by the computer system 100. The responses may also include a description of at least one or more of the outputted visual representations 2338 in relation to the desired perception, a rationale for ranking the set of outputted visual representations 2338 against a specific desired perception and any one of its opposite and/or a description of an emotion of the user when viewing one or more of the outputted visual representations 2338.

The received classification information may be further processed. For example, an initial desired perception is output on monitor 110 from the computer system 100 in an array 2332. Different outputted visual representations 2338 to be chosen by one or more users as the best representative samples that reinforce that desired perception is then output on monitor 110 from the computer system 100. Then, the user observations and rationale for ranking of the choices are collected. Also, the desired perception is refined to represent a more clearly focused desired perception that also shares a clear consensus of understanding.

Referring to FIG. 22, a set of visual concepts are created that leverage the cues identified from the one or more outputted visual representations 2338. A perceptual map 2369 is output from the computer system 100 on the output device 110. The user 2326 is then enabled to place each of the set of visual concepts on the perceptual map 2369. The placement of the visual concepts on the perceptual map 2329 by the user 2326 is analyzed and organized based on the analysis.

Referring to FIG. 11, a plurality of terminals 2302 may be connected to a computer system 2304 via a network 2300. Accordingly, the classification information for the one or more outputted visual representations 2338 is received from at least one user at each of the computer terminals 2302.

Another aspect of the invention provides a method for performing, on a plurality of computer terminals 2302 coupled via a network of computer systems 2300 having one or more processors, perception management using a plurality of visual representations 2310 stored in a database 2306, the one or more processors and the database 2306 being coupled to the network of computer systems 2300. The representations 2310 include one or more particular visual representations 2338 as well as one or more other visual representations. Each visual representation 2310 embodies cues, whereupon viewing by humans, these related cues send signals that influence human behavior by synergistically triggering desired perceptions.

The method also includes outputting from the network of computer systems 2300 to one or more users one or more of the particular visual representations 2338 on one or more output devices 114 coupled to one or more of the computer terminals 2302 coupled to the network of computer systems 2300. The classification information for the one or more outputted particular visual representations 2338 is then received from the one or more users using one or more input devices 114 coupled to the one or more terminals 2302 on the network of computer systems 2300. The method also includes storing the classification information received from the one or more users for the one or more outputted particular visual representations 2338 in the database 2306 coupled to the network of computer systems 2300.

Then, by cross-referencing through access to the database 2306 the received classification information for one or more of the outputted particular visual representations 2338 with the classification information for one or more of the other visual representations, the received classification information for one or more of the plurality of visual representations 2310 is distilled in order to identify the related cues that influence human behavior.

Also, the received classification information of one or more of the outputted particular visual representations 2338 is distilled in order to identify the related cues from any one of one or more of the plurality of visual representations 2310, the distilled cues relating to any determined one or more of the plurality of visual representations 2310, including one or more of the particular visual representations 2338 or one or more of the other visual representations. The received classification information of one or more of the outputted particular visual representations 2338 also includes classification information of one or more elements of the outputted particular visual representations 2338 and the distilled cues relate to any determined one or more of the elements within one or more of the plurality of visual representations 2310.

As discussed above, a perceptual map 2369 is output from the one or more computer terminals 2302 on each of the output devices 110. Then, the user is enabled to place each of the plurality of visual representations 2338 on the perceptual map 2369.

A further aspect of the present invention provides an apparatus for performing perception management. The apparatus includes a computer system 100 having one or more processors 102 and a data storage system 105. The data storage system 105 includes one or more data storage devices 106 coupled thereto. The data storage system 105 stores a database 2327 containing a plurality of visual representations, the one or more processors and the database 2327 being coupled to the computer system 100. The representations 2310 include one or more particular visual representations 2338 as well as one or more other visual representations. Each visual representation 2310 embodies cues, whereupon viewing by humans, these related cues send signals that influence human behavior by synergistically triggering desired perceptions.

The apparatus also includes one or more computer programs 117, operable to run on the computer system 100, for outputting from the computer system to a user 2326 one or more of the particular visual representations 2338 on an output device 110 coupled to the computer system 100. Classification information for the one or more outputted particular visual representations 2338 is received from the user 2326 using an input device 114 coupled to the one or more processors 102 in the computer system 100. The classification information received from the user 2326 for the one or more outputted particular visual representations 2338 in then stored in the database 2327.

Then, by cross-referencing through access to the database 2327 the received classification information for one or more of the outputted particular visual representations 2338 with the classification information for one or more of the other visual representations, the received classification information for one or more of the plurality of visual representations 2310 is distilled in order to identify the related cues that influence human behavior.

Also, the received classification information of one or more of the outputted particular visual representations 2338 is distilled in order to identify the related cues from any one of one or more of the plurality of visual representations 2310, the distilled cues relating to any determined one or more of the plurality of visual representations 2310, including one or more of the particular visual representations 2338 or one or more of the other visual representations. The received classification information of one or more of the outputted particular visual representations 2338 also includes classification information of one or more elements of the outputted particular visual representations 2338 and the distilled cues relate to any determined one or more of the elements within one or more of the plurality of visual representations 2310.

Still another aspect of the present invention provides an apparatus for performing perception management on a plurality of computer systems 2302 having one or more processors are coupled to each other via a network, for example the Internet 2300.

Still a further aspect of the invention provides an article of manufacture that includes a computer program carrier 106 readable by a computer system 100 having one or more processors 102 and embodying one or more instructions executable by the computer system 100 to perform a method for performing perception management as discussed above.

Yet another aspect of the invention provides an article of manufacture that includes a computer program carrier readable by one or more computer systems 2302 having one or more processors among a plurality of computer systems 2302 having one or more processors coupled via a network, for example the Internet 2300. The computer system embodies one or more instructions executable by the one or more computer systems 2302 to perform a method for performing perception management as discussed above.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

The claimed invention is:

1. A method for performing, on a computer system having one or more processors, perception management using a plurality of visual representations stored in a database, the one or more processors and the database being coupled to the computer system, the representations including one or more particular visual representations as well as one or more other visual representations, each visual representation embodying cues, whereupon viewing by humans, these related cues send signals that influence human behavior by synergistically triggering desired perceptions, the method comprising:
outputting from the computer system to a user one or more of the particular visual representations on an output device coupled to the computer system;
receiving from the user classification information for the one or more outputted particular visual representations using an input device coupled to the one or more processors in the computer system; and
storing the classification information received from the user for the one or more outputted particular visual representations in the database;
wherein, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

2. The method of claim 1, wherein:
the received classification information for one or more of the outputted particular visual representations is distilled in order to identify the related cues from any one of one or more of the plurality of visual representations; and
the distilled cues relate to any determined one or more of the plurality of visual representations, including one or more of the particular visual representations or one or more of the other visual representations.

3. The method of claim 2, wherein:
the received classification information for one or more of the outputted particular visual representations includes classification information of one or more elements of the outputted particular visual representations; and
the distilled cues relate to any determined one or more of the elements within one or more of the plurality of visual representations.

4. The method of claim 1, further comprising inputting a database of a plurality of selected particular visual representations whereby, the selected particular visual representations can be altered as desired by the user.

5. The method of claim 4, wherein the database of the selected particular visual representations is created by the user.

6. The method of claim 4, wherein the database of the selected particular visual representations is inputted from such a database created by a third party.

7. The method of claim 1, wherein each visual representation in the database is associated with an agent that identifies relationships between one or more of the particular visual representations and one or more of the other visual representations stored in the database.

8. The method of claim 1, wherein:
the classification information for one or more of the outputted particular visual representations comprises ratings; and,
the system processes the ratings in order to determine an average rating for each outputted particular visual representation.

9. The method of claim 1, wherein:
the classification information for one or more of the outputted particular visual representations comprises ratings; and
the system processes the ratings in order to identify a ranking of one or more of the outputted particular visual representations.

10. The method of claim 1, comprising capturing responses from the user related to one or more of the outputted particular visual representations.

11. The method of claim 10, wherein the response comprises a description of at least one of the one or more outputted particular visual representations in relation to the desired perception.

12. The method of claim 10, wherein the response comprises:
a rationale for ranking a set of one or more outputted particular visual representations against a specific desired perception and any one of its opposite; and
a description of an emotion of the user when viewing one or more of the outputted particular visual representations.

13. The method of claim 1, comprising capturing responses from a third party related to one or more of the outputted particular visual representations.

14. The method of claim 1, further comprising:
processing the received classification information for the one or more outputted particular visual representations;
outputting from the computer system an initial desired perception;
outputting from the computer system different visual representations to be chosen by one or more users as the best representative samples that reinforce that desired perception; and
collecting user observations and rationale for ranking of the choices.

15. The method of claim 14, further comprising refining the desired perception to represent a more clearly focused desired perception that also shares a clear consensus of understanding.

16. The method of claim 1, further comprising:
creating a set of visual concepts that leverage the cues identified from the one or more of the outputted particular visual representations;
outputting from the computer system a perceptual map on the output device; and
enabling the user to place each of the set of visual concepts on the perceptual map.

17. The method of claim 16, further comprising:
analyzing the placement of the visual concepts on the perceptual map; and
organizing the visual concepts on the perceptual map based on the analysis.

18. The method of claim 1, further comprising connecting the computer system to a plurality of terminals via a network, wherein the step of receiving the classification information further comprises the step of receiving the classification information for one or more of the outputted particular visual representations from at least one user at each of the computer terminals.

19. A method for performing, on a plurality of computer terminals coupled via a network of computer systems having one or more processors, perception management using a plurality of visual representations stored in a database, the one or more processors and the database being coupled to the network of computer systems, the representations including one or more particular visual representations as well as one or more other visual representations, each visual representation embodying cues, whereupon viewing by humans, these related cues send signals that influence human behavior by synergistically triggering desired perceptions, the method comprising:
outputting from the network of computer systems to one or more users one or more of the particular visual representations on one or more output devices coupled to one or more of the computer terminals coupled to the network of computer systems;
receiving from the one or more users classification information for the one or more outputted particular visual representations using one or more input devices coupled to the one or more terminals on the network of computer systems; and
storing the classification information received from the one or more users for the one or more outputted particular visual representations in the database coupled to the network of computer systems;
wherein, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

20. The method of claim 19, wherein:
the received classification information for one or more of the outputted particular visual representations is distilled in order to identify the related cues from any one of one or more of the plurality of visual representations; and
the distilled cues relate to any determined one or more of the plurality of visual representations, including one or more of the particular visual representations or one or more of the other visual representations.

21. The method of claim 20, wherein:
the received classification information for one or more of the outputted particular visual representations includes classification information of one or more elements of the outputted particular visual representations; and
the distilled cues relate to any determined one or more of the elements within one or more of the plurality of visual representations.

22. The method of claim 19, further comprising inputting a database of a plurality of selected particular visual representations whereby, the selected particular visual representations can be altered as desired by one or more of the users.

23. The method of claim 22, wherein the database of the selected particular visual representations is created by one or more of the users.

24. The method of claim 22, wherein the database of the selected particular visual representations is inputted from such a database created by a third party.

25. The method of claim 19, wherein each visual representation in the database is associated with an agent that identifies relationships between one or more of the particular visual representations and one or more of the other visual representations stored in the database.

26. The method of claim 19, wherein:
the classification information for one or more of the outputted particular visual representations comprises ratings; and,
the system processes the ratings in order to determine an average rating for each outputted particular visual representation.

27. The method of claim 19, wherein:
the classification information for one or more of the outputted particular visual representations comprises ratings; and
the system processes the ratings in order to identify a ranking of one or more of the outputted particular visual representations.

28. The method of claim 19, comprising capturing responses from the one or more users related to one or more of the outputted particular visual representations.

29. The method of claim 28, wherein the response comprises a description of at least one of the one or more outputted particular visual representations in relation to the desired perception.

30. The method of claim 28, wherein the response comprises:
a rationale for ranking a set of one or more outputted particular visual representations against a specific desired perception and any one of its opposite; and
a description of an emotion of the user when viewing one or more of the outputted particular visual representations.

31. The method of claim 19, comprising capturing responses from a third party related to one or more of the outputted particular visual representations.

32. The method of claim 19, further comprising:
processing the received classification information for the one or more outputted particular visual representations;
outputting from the terminals coupled to the network of computer systems an initial desired perception;
outputting from the terminals coupled to the network of computer systems different visual representations to be chosen by one or more users as the best representative samples that reinforce that desired perception; and
collecting observations by the one or more users and rationale for ranking of the choices.

33. The method of claim 32, further comprising refining the desired perception to represent a more clearly focused desired perception that also shares a clear consensus of understanding.

34. The method of claim 19, further comprising:
creating a set of visual concepts that leverage the cues identified from the one or more of the outputted particular visual representations;
outputting from the network of computer systems a perceptual map on the one or more terminals coupled to network of computer systems; and
enabling the user to place each of the set of visual concepts on the perceptual map.

35. The method of claim 34, further comprising:
analyzing the placement of the visual concepts on the perceptual map; and
organizing the visual concepts on the perceptual map based on the analysis.

36. An apparatus for performing perception management, comprising:
a computer system having one or more processors and a data storage system including one or more data storage devices coupled thereto, wherein the data storage system stores a database containing a plurality of visual representations, the one or more processors and the database being coupled to the computer system, the representations including one or more particular visual representations as well as one or more other visual representations, each visual representation embodying cues, whereupon viewing by humans, these related cues send signals that influence human behavior by synergistically triggering desired perceptions; and
one or more computer programs, operable to run on the computer system, for outputting from the computer system to a user one or more of the particular visual representations on an output device coupled to the computer system, receiving from the user classification information for the one or more outputted particular visual representations using an input device coupled to the one or more processors in the computer system, and storing the classification information received from the user for the one or more outputted particular visual representations in the database;
wherein, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

37. The apparatus of claim 36, wherein:
the received classification information for one or more of the outputted particular visual representations is distilled in order to identify the related cues from any one of one or more of the plurality of visual representations; and
the distilled cues relate to any determined one or more of the plurality of visual representations, including one or more of the particular visual representations or one or more of the other visual representations.

38. The apparatus of claim 37, wherein:
the received classification information for one or more of the outputted particular visual representations includes classification information of one or more elements of the outputted particular visual representations; and
the distilled cues relate to any determined one or more of the elements within one or more of the plurality of visual representations.

39. The apparatus of claim 36, further comprising means for inputting a database of a plurality of selected particular visual representations whereby, the selected particular visual representations can be altered as desired by the user.

40. The apparatus of claim 39, wherein the database of the selected particular visual representations is created by the user.

41. The apparatus of claim 39, wherein the database of the selected particular visual representations is inputted from such a database created by a third party.

42. The apparatus of claim 36, wherein each visual representation in the database is associated with an agent that identifies relationships between one or more of the particular visual representations and one or more of the other visual representations stored in the database.

43. The apparatus of claim 36, wherein:
the classification information for one or more of the outputted particular visual representations comprises ratings; and,
the system processes the ratings in order to determine an average rating for each outputted particular visual representation.

44. The apparatus of claim 36, wherein:
the classification information for one or more of the outputted particular visual representations comprises ratings; and
the system processes the ratings in order to identify a ranking of one or more of the outputted particular visual representations.

45. The apparatus of claim 36, comprising means for capturing responses from the user related to one or more of the outputted particular visual representations.

46. The apparatus of claim 45, wherein the response comprises a description of at least one of the one or more outputted particular visual representations in relation to the desired perception.

47. The apparatus of claim 45, wherein the response comprises:
a rationale for ranking a set of one or more outputted particular visual representations against a specific desired perception and any one of its opposite; and
a description of an emotion of the user when viewing one or more of the outputted particular visual representations.

48. The apparatus of claim 36, comprising means for capturing responses from a third party related to one or more of the outputted particular visual representations.

49. The apparatus of claim 36, further comprising:
means for processing the received classification information for the one or more outputted particular visual representations;
means for outputting from the computer system an initial desired perception;
means for outputting from the computer system different visual representations to be chosen by one or more users as the best representative samples that reinforce that desired perception; and
means for collecting user observations and rationale for ranking of the choices.

50. The apparatus of claim 49, further comprising refining the desired perception to represent a more clearly focused desired perception that also shares a clear consensus of understanding.

51. The apparatus of claim 36, further comprising:
means for creating a set of visual concepts that leverage the cues identified from the one or more of the outputted particular visual representations;
means for outputting from the computer system a perceptual map on the output device; and
means for enabling the user to place each of the set of visual concepts on the perceptual map.

52. The apparatus of claim 51, further comprising:
means for analyzing the placement of the visual concepts on the perceptual map; and
means for organizing the visual concepts on the perceptual map based on the analysis.

53. The apparatus of claim 36, further comprising means for connecting the computer system to a plurality of terminals via a network, wherein the step of receiving the classification information further comprises the step of receiving the classification information for one or more of the outputted particular visual representations from at least one user at each of the computer terminals.

54. An apparatus for performing perception management, comprising:
a network of computer systems having one or more processors and at least one data storage system including one or more data storage devices coupled thereto, wherein the data storage system stores a database containing a plurality of visual representations, the one or more processors being coupled to each of the computer systems and the database being coupled to the network of computer systems, the representations including one or more particular visual representations as well as one or more other visual representations, each visual representation embodying cues, whereupon viewing by humans, these related cues send signals that influence human behavior by synergistically triggering desired perceptions; and
one or more computer programs, operable to run on one or more of the computer systems, for outputting from the network of computer systems to one or more users one or more of the particular visual representations on one or more output devices coupled to the network of computer systems, receiving from the one or more users classification information for the one or more outputted particular visual representations using one or more input devices coupled to the network of computer systems, and storing the classification information received from the one or more users for the one or more outputted particular visual representations in the database coupled to the network of computer systems;
wherein, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

55. The apparatus of claim 54, wherein:
the received classification information for one or more of the outputted particular visual representations is distilled in order to identify the related cues from any one of one or more of the plurality of visual representations; and
the distilled cues relate to any determined one or more of the plurality of visual representations, including one or more of the particular visual representations or one or more of the other visual representations.

56. The apparatus of claim 55, wherein:
the received classification information for one or more of the outputted particular visual representations includes classification information of one or more elements of the outputted particular visual representations; and
the distilled cues relate to any determined one or more of the elements within one or more of the plurality of visual representations.

57. The apparatus of claim 54, further comprising means for inputting a database of a plurality of selected particular visual representations whereby the selected particular visual representations can be altered as desired by the one or more users.

58. The apparatus of claim 57, wherein the database of the selected particular visual representations is created by the one or more users.

59. The apparatus of claim 57, wherein the database of the selected particular visual representations is inputted from such a database created by a third party.

60. The apparatus of claim 54, wherein each visual representation in the database is associated with an agent that identifies relationships between one or more of the particular visual representations and one or more of the other visual representations stored in the database.

61. The apparatus of claim 54, wherein:
the classification information for one or more of the outputted particular visual representations comprises ratings; and,
the system processes the ratings in order to determine an average rating for each outputted particular visual representation.

62. The apparatus of claim 54, wherein:
the classification information for one or more of the outputted particular visual representations comprises ratings; and
the system processes the ratings in order to identify a ranking of one or more of the outputted particular visual representations.

63. The apparatus of claim 54, comprising means for capturing responses from the one or more users related to one or more of the outputted particular visual representations.

64. The apparatus of claim 63, wherein the response comprises a description of at least one of the one or more outputted particular visual representations in relation to the desired perception.

65. The apparatus of claim 63, wherein the response comprises:
a rationale for ranking a set of one or more outputted particular visual representations against a specific desired perception and any one of its opposite; and
a description of an emotion of the one or more users when viewing one or more of the outputted particular visual representations.

66. The apparatus of claim 54, comprising means for capturing responses from a third party related to one or more of the outputted particular visual representations.

67. The apparatus of claim 54, further comprising:
means for processing the received classification information for the one or more outputted particular visual representations;
means for outputting from the computer system an initial desired perception;
means for outputting from the computer system different visual representations to be chosen by one or more users as the best representative samples that reinforce that desired perception; and
means for collecting one or more users observations and rationale for ranking of the choices.

68. The apparatus of claim 67, further comprising refining the desired perception to represent a more clearly focused desired perception that also shares a clear consensus of understanding.

69. The apparatus of claim 54, further comprising:
means for creating a set of visual concepts that leverage the cues identified from the one or more of the outputted particular visual representations;
means for outputting from the computer system a perceptual map on the output device; and
means for enabling the one or more users to place each of the set of visual concepts on the perceptual map.

70. The apparatus of claim 69, further comprising:
means for analyzing the placement of the visual concepts on the perceptual map; and
means for organizing the visual concepts on the perceptual map based on the analysis.

71. An article of manufacture comprising a computer program carrier readable by a computer system having one or more processors and embodying one or more instructions executable by the computer system to perform a method for performing, on a computer system having one or more processors, perception management using a plurality of visual representations stored in a database, the one or more processors and the database being coupled to the computer system, the representations including one or more particular visual representations as well as one or more other visual representations, each visual representation embodying cues, whereupon viewing by humans, these related cues send signals that influence human behavior by synergistically triggering desired perceptions, the method comprising:
outputting from the computer system to a user one or more of the particular visual representations on an output device coupled to the computer system;
receiving from the user classification information for the one or more outputted particular visual representations using an input device coupled to the one or more processors in the computer system; and
storing the classification information received from the user for the one or more outputted particular visual representations in the database;
wherein, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

72. The article of manufacture method of claim 71, wherein:
the received classification information for one or more of the outputted particular visual representations is distilled in order to identify the related cues from any one of one or more of the plurality of visual representations; and
the distilled cues relate to any determined one or more of the plurality of visual representations, including one or more of the particular visual representations or one or more of the other visual representations.

73. The article of manufacture of claim 72, wherein:
the received classification information for one or more of the outputted particular visual representations includes classification information of one or more elements of the outputted particular visual representations; and
the distilled cues relate to any determined one or more of the elements within one or more of the plurality of visual representations.

74. The article of manufacture of claim 71, further comprising inputting a database of a plurality of selected particular visual representations whereby the selected particular visual representations can be altered as desired by the user.

75. The article of manufacture of claim 74, wherein the database of the selected particular visual representations is created by the user.

76. The article of manufacture of claim 74, wherein the database of the selected particular visual representations is inputted from such a database created by a third party.

77. The article of manufacture of claim 71, wherein each visual representation in the database is associated with an agent that identifies relationships between one or more of the particular visual representations and one or more of the other visual representations stored in the database.

78. The article of manufacture of claim 71, wherein:
the classification information for one or more of the outputted particular visual representations comprises ratings; and,
the system processes the ratings in order to determine an average rating for each outputted particular visual representation.

79. The article of manufacture of claim 71, wherein:
the classification information for one or more of the outputted particular visual representations comprises ratings; and
the system processes the ratings in order to identify a ranking of one or more of the outputted particular visual representations.

80. The article of manufacture of claim 71, comprising capturing responses from the user related to one or more of the outputted particular visual representations.

81. The article of manufacture of claim 80, wherein the response comprises a description of at least one of the one or more outputted particular visual representations in relation to the desired perception.

82. The article of manufacture of claim 80, wherein the response comprises:
a rationale for ranking a set of one or more outputted particular visual representations against a specific desired perception and any one of its opposite; and
a description of an emotion of the user when viewing one or more of the outputted particular visual representations.

83. The article of manufacture of claim 71, comprising capturing responses from a third party related to one or more of the outputted particular visual representations.

84. The article of manufacture of claim 71, further comprising:
processing the received classification information for the one or more outputted particular visual representations;
outputting from the computer system an initial desired perception;
outputting from the computer system different visual representations to be chosen by one or more users as the best representative samples that reinforce that desired perception; and
collecting user observations and rationale for ranking of the choices.

85. The article of manufacture of claim 84, further comprising refining the desired perception to represent a more clearly focused desired perception that also shares a clear consensus of understanding.

86. The article of manufacture of claim 71, further comprising:
creating a set of visual concepts that leverage the cues identified from the one or more of the outputted particular visual representations;
outputting from the computer system a perceptual map on the output device; and
enabling the user to place each of the set of visual concepts on the perceptual map.

87. The article of manufacture of claim 86, further comprising:
analyzing the placement of the visual concepts on the perceptual map; and
organizing the visual concepts on the perceptual map based on the analysis.

88. The article of manufacture of claim 71, further comprising connecting the computer system to a plurality of terminals via a network, wherein the step of receiving the classification information further comprises the step of receiving the classification information for one or more of the outputted particular visual representations from at least one user at each of the computer terminals.

89. An article of manufacture comprising a computer program carrier readable by one or more computer systems having one or more processors among a plurality of computer systems having one or more processors coupled via a network and embodying one or more instructions executable by the one or more computer systems to perform a method for performing, on a plurality of computer systems coupled via a network of computer systems having one or more processors, perception management using a plurality of visual representations stored in a database, the one or more processors and the database being coupled to the network of computer systems, the representations including one or more particular visual representations as well as one or more other visual representations, each visual representation embodying cues, whereupon viewing by humans, these related cues send signals that influence human behavior by synergistically triggering desired perceptions, the method comprising:
outputting from the network of computer systems to one or more users one or more of the particular visual representations on one or more output devices coupled to one or more of the computer terminals coupled to the network of computer systems;
receiving from the one or more users classification information for the one or more outputted particular visual representations using an input device coupled to the one or more terminals on the network of computer systems; and
storing the classification information received from the one or more users for the one or more outputted particular visual representations in the database coupled to the network of computer systems;
wherein, by cross-referencing through access to the database the received classification information for one or more of the outputted particular visual representations with the classification information for one or more of the other visual representations, the received classification information for one or more of the plurality of visual representations is distilled in order to identify the related cues that influence human behavior.

90. The article of manufacture method of claim 89, wherein:
the received classification information for one or more of the outputted particular visual representations is distilled in order to identify the related cues from any one of one or more of the plurality of visual representations; and
the distilled cues relate to any determined one or more of the plurality of visual representations, including one or more of the particular visual representations or one or more of the other visual representations.

91. The article of manufacture of claim 90, wherein:
the received classification information for one or more of the outputted particular visual representations includes classification information of one or more elements of the outputted particular visual representations; and
the distilled cues relate to any determined one or more of the elements within one or more of the plurality of visual representations.

92. The article of manufacture of claim 89, further comprising inputting a database of a plurality of selected particular visual representations whereby the selected particular visual representations can be altered as desired by the one or more users.

93. The article of manufacture of claim 92, wherein the database of the selected particular visual representations is created by the one or more users.

94. The article of manufacture of claim 92, wherein the database of the selected particular visual representations is inputted from such a database created by a third party.

95. The article of manufacture of claim 89, wherein each visual representation in the database is associated with an agent that identifies relationships between one or more of the particular visual representations and one or more of the other visual representations stored in the database.

96. The article of manufacture of claim 89, wherein:
the classification information for one or more of the outputted particular visual representations comprises ratings; and,
the system processes the ratings in order to determine an average rating for each outputted particular visual representation.

97. The article of manufacture of claim 89, wherein:
the classification information for one or more of the outputted particular visual representations comprises ratings; and
the system processes the ratings in order to identify a ranking of one or more of the outputted particular visual representations.

98. The article of manufacture of claim 89, comprising capturing responses from the one or more users related to one or more of the outputted particular visual representations.

99. The article of manufacture of claim 98, wherein the response comprises a description of at least one of the one or more outputted particular visual representations in relation to the desired perception.

100. The article of manufacture of claim 98, wherein the response comprises:
a rationale for ranking a set of one or more outputted particular visual representations against a specific desired perception and any one of its opposite; and
a description of an emotion of the one or more users when viewing one or more of the outputted particular visual representations.

101. The article of manufacture of claim 89, comprising capturing responses from a third party related to one or more of the outputted particular visual representations.

102. The article of manufacture of claim 89, further comprising:
processing the received classification information for the one or more outputted particular visual representations;
outputting from the computer system an initial desired perception;
outputting from the computer system different visual representations to be chosen by one or more users as the best representative samples that reinforce that desired perception; and
collecting one or more users observations and rationale for ranking of the choices.

103. The article of manufacture of claim 102, further comprising refining the desired perception to represent a more clearly focused desired perception that also shares a clear consensus of understanding.

104. The article of manufacture of claim 89, further comprising:
creating a set of visual concepts that leverage the cues identified from the one or more of the outputted particular visual representations;
outputting from the computer system a perceptual map on the output device; and
enabling the one or more users to place each of the set of visual concepts on the perceptual map.

105. The article of manufacture of claim 104, further comprising:
analyzing the placement of the visual concepts on the perceptual map; and
organizing the visual concepts on the perceptual map based on the analysis.

106. The article of manufacture of claim 89, further comprising connecting the computer system to a plurality of terminals via a network, wherein the step of receiving the classification information further comprises the step of receiving the classification information for one or more of the outputted particular visual representations from at least one of the one or more users at each of the computer terminals.
